(19) United States
(12) Patent Application Publication
(10) Pub. No.: US 2007/0136735 A1
(43) Pub. Date: Jun. 14, 2007

(54) Disc drive apparatus

(75) Inventor: Susumu Hisatomi, Fukaya-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/635,021

(22) Filed: Dec. 7, 2006

(30) Foreign Application Priority Data
Dec. 9, 2005 (JP) 2005-356952

(51) Int. Cl. G11B 17/04; G11B 33/02

(52) U.S. Cl. 720/653; 720/601

(57) ABSTRACT

According to one embodiment, a disc drive apparatus includes a collapsible portion that performs an extending operation in response to insertion of a disc into a disc insertion port. A disc detecting mechanism has a detecting portion detecting insertion of a recording medium, a disc detecting stopper, a first disc detecting lever, and a second disc detecting lever on the first disc detecting lever. In response to insertion of the recording medium, the first and second disc detecting levers are rotated to cause a second abutting portion of the second disc detecting lever abuts against the disc detecting stopper and moves the medium detecting member from a first position to an intermediate position. With further insertion of the recording medium, the second disc detecting lever rotates to rotate the first disc detecting lever to move the medium detecting member from the intermediate position to a second position.

### CROSS-REFERENCE TO RELATED APPLICATIONS

This application is based upon and claims the benefit of priority from Japanese Patent Application No. 2005-356952, filed Dec. 9, 2005, the entire contents of which are incorporated herein by reference.

### BACKGROUND

1. Field

One embodiment of the invention relates to a disc drive apparatus that executes information processing on a disc-shaped recording medium, and in particular, to a retractable disc drive apparatus that can be compactified by reducing its size while unused.

2. Description of the Related Art

In recent years, the sizes of disc drive apparatuses have been significantly reduced in connection with miniaturized disc driving mechanisms and the like. However, disc drive apparatuses are generally still larger than discs used as recording media.

In the disc drive apparatus, data is normally recorded on or reproduced from a disc housed in a disc housing area defined inside the device. Accordingly, the disc drive apparatus needs to comprise a disc housing area large enough to house the entire disc. This restriction makes it difficult to reduce the size of the disc drive apparatus below that of the disc.

Various configurations have been contemplated in order to meet requests for reduced sizes and improved reliability and operability. For example, Jpn. Pat. Appln. KOKAI Publication No. 2000-187973 (paragraphs 0007 to 0009, FIG. 1) discloses a disc drive apparatus with improved portability which ensures a sufficient disc housing area while in use and which allows a housing to be compactified while unused regardless of external size of the recording media disc used. According to this disc drive apparatus, the housing is composed of a fixed portion and a collapsible portion that is extended and retracted with respect to the fixed portion. Extending the collapsible portion provides a disc housing area in the housing. The housing has a cover that allows the disc to be carried into and out of the disc housing area. The cover is opened after the extending operation of the collapsible portion is completed.

However, the device shown in Jpn. Pat. Appln. KOKAI Publication No. 2000-187973 requires the disc to be manually installed in a disc driving portion that reads and writes information from and to the disc being rotationally driven. The device thus leaves room for improvement in terms of operability. Further, when the cover, which allows the disc to be carried into and out of the disc housing area, is attached to the device, appropriate operation areas must be provided not only in the extending and retracting direction of the collapsible portion but also in a cover opening and closing direction. It is thus very difficult to save spaces while the device is in use. The device also has difficulty being built into another apparatus.

Further, Jpn. Pat. Appln. KOKAI Publication NO. 2001-143351 discloses what is called a slot-in type disc player. This disc player comprises conveying means for conveying an inserted disc. The conveying means includes a disc conveying roller that abuts against a first surface of the disc to covey it. Disc detecting means has a disc abutting member that can be displaced between a detection position and a non-detection position. A second surface of the disc inserted through a slot in the disc player abuts against the disc abutting member, which is then displaced from the non-detection position to the detection position. The insertion of the disc is thus detected.

However, the disc drive apparatus disclosed in Jpn. Pat. Appln. KOKAI Publication No. 2001-143351 requires a disc installation space larger than the disc used. This makes it difficult to reduce the size of the device below that of the disc. Further, the disc detecting means configured as described above is not designed to be applicable to small-sized disc drive apparatuses. Moreover, a delay in detection or the like may result from an error in the machining or assembly of the disc abutting member.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing a planar display apparatus according to a first embodiment of the present invention;

FIG. 2 is an exemplary perspective view showing how a disc drive apparatus in the display apparatus is used;

FIGS. 3A, 3B, and 3C are an exemplary plan view showing a disc driving portion of the disc driving device mounted in the display apparatus, an exemplary sectional view of an essential part of the disc driving portion as viewed from its left side, and an exemplary sectional view of the essential part also as viewed from the left side;

FIG. 4 is an exemplary side view showing the disc driving portion;

FIG. 5 is an exemplary bottom view of the disc driving portion;

FIGS. 6A and 6B are an exemplary partly cutaway front view of the disc drive apparatus as viewed from its front and an exemplary partly enlarged sectional view of the disc drive apparatus;

FIGS. 7A, 7B, and 7C are an exemplary top view, an exemplary right side view, and an exemplary rear view showing a collapsible portion of the disc drive apparatus;

FIG. 8 is an exemplary side view showing that the collapsible portion of the disc drive apparatus is retracted;

FIG. 9 is an exemplary side view showing that the collapsible portion of the disc drive apparatus is extended;

FIG. 10 is an exemplary plan view showing a driving portion on a base member of the disc drive apparatus;

FIG. 11 is an exemplary timing chart illustrating state changes resulting from movement of a cam slider in the disc drive apparatus;

FIGS. 12A and 12B are exemplary plan views showing a standby state on the base member of the disc. drive apparatus;

FIGS. 13A and 13B are exemplary plan views showing a clamp state on the base member of the disc drive apparatus;

FIGS. 14A and 14B are exemplary plan views showing an eject state on the base member of the disc drive apparatus;

FIGS. 15A and 15B are exemplary sectional views of essential parts of the disc drive apparatus as viewed from its right;

FIGS. 16A and 16B are an exemplary plan view and an exemplary sectional view showing essential parts of the driving portion provided on the base member 24 of the disc drive apparatus;

FIGS. 17A, 17C, and 17E are exemplary plan views showing essential parts of the driving portion provided on the base member 24 of the disc drive apparatus;

FIGS. 17B, 17D, and 17F are exemplary side views of an essential part of the disc drive apparatus as viewed from its rear;

FIGS. 18A and 18B are exemplary plan views showing the standby state on a base top of the disc drive apparatus;

FIGS. 19A and 19B are exemplary plan views showing the standby state on the base top of the disc drive apparatus;

FIGS. 20A and 20B are exemplary plan views showing the standby state on the base top of the disc drive apparatus;

FIGS. 21A and 21B are exemplary plan views showing the clamp state on the base top of the disc drive apparatus;

FIGS. 22A and 22B are exemplary plan views showing the eject state on the base top of the disc drive apparatus;

FIGS. 23A and 23B are exemplary plan views showing the eject state on the base top of the disc drive apparatus;

FIGS. 24A, 24B, and 24C are exemplary plan views and an exemplary side view showing operations of a disc holding portion at a leading end of a left disc lever in the disc drive apparatus;

FIGS. 25A and 25B are exemplary sectional views of an essential part of a disc detecting stopper in the disc drive apparatus as viewed from its right side;

FIGS. 26A, 26B, 26C, and 26D are exemplary plan views, an exemplary front view, and an exemplary side view showing the standby state on the base top of the disc drive apparatus which is observed when a smaller-diameter disc is inserted;

FIGS. 27A, 27B, and 27C are exemplary plan views and a front view showing the clamp state on the base top of the disc drive apparatus which is observed when a smaller-diameter disc is inserted;

FIGS. 28A and 28B are an exemplary plan view showing the standby state of an essential part of a clamp member driving mechanism on the base top of the disc drive apparatus and an exemplary schematic diagram of the standby state as viewed from the front of the disc drive apparatus;

FIGS. 29A and 29B are an exemplary plan view of state of an essential part of the clamp member driving mechanism on the base top of the disc drive apparatus during a mode change, and an exemplary schematic diagram of the same state as viewed from the front of the disc drive apparatus;

FIG. 30 is an exemplary plan view showing the state of essential part of the clamp member driving mechanism on the base top of the disc drive apparatus during a mode change;

FIGS. 31A and 31B are an exemplary plan view showing the clamp state of essential part of the clamp member driving mechanism on the base top of the disc drive apparatus, and an exemplary schematic diagram of the same state as viewed from the front of the disc drive apparatus; and

FIG. 32 is an exemplary block diagram schematically showing a control system of the disc drive apparatus.

### DETAILED DESCRIPTION

An embodiment of the invention will be described below in detail with reference to the drawings. In general, according to one embodiment of the invention, a disc drive apparatus comprises: a disc driving portion which supports and rotates a disc-shaped recording medium to execute information processing on the recording medium; a fixed portion on which the disc driving portion is mounted; a collapsible portion which is supported to be movable, in a predetermined extending and retracting direction, between a retracted position where the collapsible portion overlaps the fixed portion and an extended portion where the collapsible portion at least partly projects from the fixed portion to define a disc housing area capable of housing the recording medium, the collapsible portion having a leading end surface provided on the extended position side with respect to the extending and retracting direction and a disc insertion port which is formed in the leading end surface and through which the recording medium is inserted into and discharged from the disc housing area in the extending and retracting direction; and a disc detecting mechanism which detects insertion of the recording medium. The disc detecting mechanism includes a detecting portion which detects insertion of the recording medium having passed through the disc insertion port; a disc detecting stopper which is provided at the fixed portion and regulates excessive insertion of the recording medium, a medium detecting member movable among a first position corresponding to non-insertion of the recording medium, a second position where the detecting portion is actuated, and an intermediate position located between the first position and the second position; and a first disc detecting lever which is rotatably provided at the fixed portion and which rotates to move the medium detecting member, and a second disc detecting lever rotatably provided on the first disc detecting lever and having a first abutting portion which abuts against the inserted recording medium and is pushed in the inserting direction of the recording medium, and a second abutting portion capable of abutting against the disc detecting stopper. In response to insertion of the recording medium, the first disc detecting lever and second disc detecting lever are rotated to cause the second abutting portion to abut against the disc detecting stopper and to move the medium detecting member from the first position to the intermediate position, and in response to further insertion of the recording medium, the second disc detecting lever abutting against the disc detecting stopper rotates around the second abutting portion to rotate the first disc detecting lever to move the medium detecting member from the intermediate position to the second position.

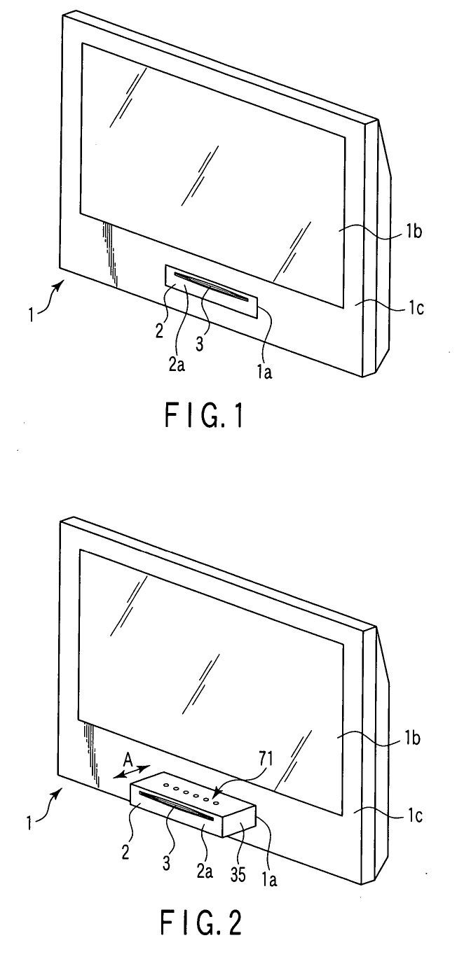

FIGS. 1 and 2 show a planar display apparatus 1 in which a disc drive apparatus 2 according to the present embodiment is mounted. The display apparatus 1 comprises an outer housing 1c shaped like a flat box, an image display panel 1b provided in the outer housing and having a display surface exposed from a display window in the outer housing, and a disc drive apparatus 2 mounted in the outer housing. The disc drive apparatus 2 is placed, for example, below the image display panel 1b in a vertical direction. The disc drive apparatus 2 is located in the front of the display device 1.

A front surface 2a of the disc drive apparatus 2 which constitutes a leading end surface has a disc insertion port 3 through which a disc 23 used as a recording medium as described below is inserted and discharged. While the disc drive apparatus 2 is unused, the front surface 2a of the disc drive apparatus is substantially flush with a front surface of the outer housing 1c.

FIG. 2 shows how the disc drive apparatus into which the disc has been inserted is used. The front surface 2a of the disc drive apparatus 2 projects from the front surface of the display apparatus 1. In this case, an operation key portion 71 is provided on an outer surface of the exposedly projecting disc drive apparatus 2; the operation key portion 71 allows the device to be set for a predetermined operation state or a stop state.

Now, the disc drive apparatus 2 will be described in detail.

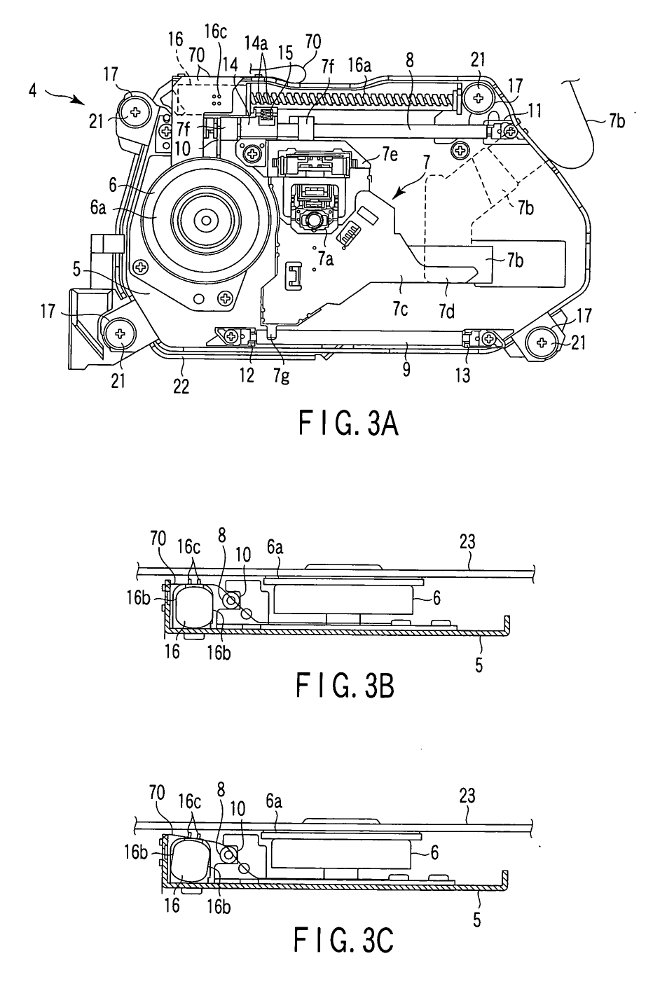

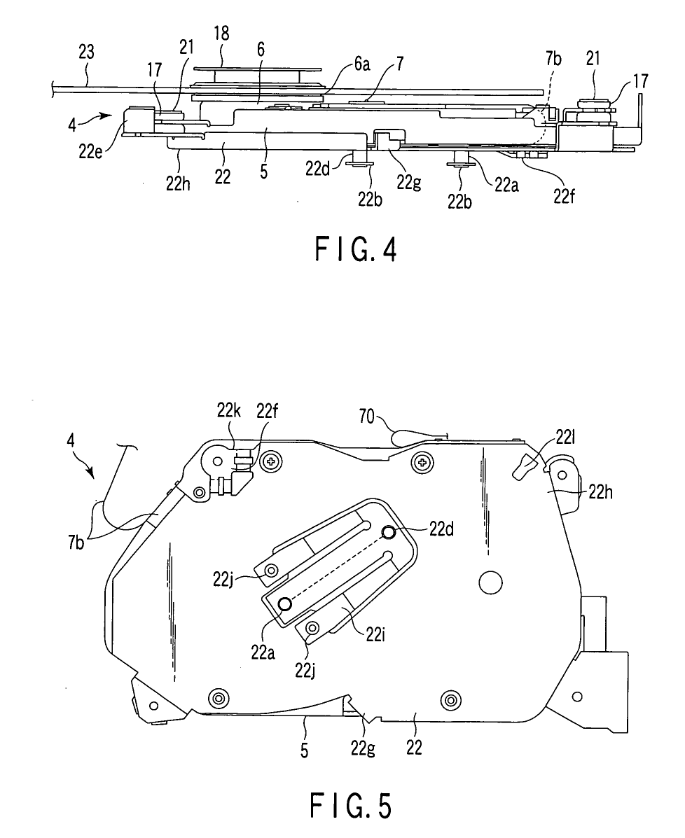

FIGS. 3A and 3B are a plan view of a disc driving portion 4 that supports and rotates the disc 23 to read or write information from or to the disc, as viewed from above, and a sectional view of an essential part of the disc driving portion 4 as viewed from the left side of the device. FIG. 4 is a side view of the disc driving portion 4 as viewed from the front surface 2a. FIGS. 3A and 4 show that an optical pickup 7 has moved to a position where it lies opposite an inner periphery of the disc. The disc driving portion 4 comprises a driving portion base 5 shaped like an almost rectangular plate and a disc driving motor 6 fixed on the driving portion base 5. The disc driving motor 6 comprises a rotor on which a turntable 6a is formed; the disc 23 is placed on the turntable 6a. The disc 23 supported on the turntable 6a is rotated by the disc driving motor 6.

The optical pickup 7 is attached to the driving portion base 5. The optical pickup 7 has a pickup portion 7a comprising a laser diode (not shown), an FPC cable 7b that is a flexible cable through which light is transmitted, a plate-shaped presser member 7c placed on a disc side of the FPC cable 7b and having an extension 7d that extends toward the outer periphery of the disc, and a holder 7e that fixes these components. The FPC cable 7b is extended toward the outer periphery of the disc, formed into a loop, and applied to a rear surface of the driving portion base 5. The FPC cable 7b is extended toward the outer periphery of the driving portion base 5 and applied to a side of the disc driving motor 6 which is bent upward in a rotating direction. The central axis of the FPC cable 7b forms a loop extending substantially parallel to a rotation axis of the dist driving motor 6, and extends upward and leftward in the figure.

The optical pickup 7 is supported by two guide shafts 8 and 9 fixed in parallel to the driving portion base 5. The optical pickup 7 is movable in an inner peripheral direction in which it approaches the disc drive motor 6 and in an outer peripheral direction in which it leaves the disc drive motor 6. The holder 7e has a pair of holding members 7f slidably engaged with a guide shaft 8 and a holding member 7g slidably engaged with a guide shaft 9. The holder 7e is slidably supported by the guide shafts 8 and 9.

The guide shaft 8 has its opposite ends supported on the driving portion base 5 by supporting members 10 and 11. The guide shaft 9 has its opposite ends supported on the driving portion base 5 by supporting members 12 and 13. An adjusting mechanism is installed in each of the three supporting members 11, 12, and 13; the adjusting mechanism is able to adjust the spacing between each of the guide shafts 8 and 9 and the driving portion base 5. The adjustment of the spacing allows the tilt of the optical pickup 7 to be adjusted.

A rack member 14 and a spring member 15 are fixed to the holder 7e, and the rack member 14 is positioned between the paired holding members 7f. A rack 14a positioned outside the optical pickup 7 is formed in the rack member 14. The rack 14a is biased toward the outside of the optical pickup 7 by the spring member 15. A stepping motor 16 is disposed outside the optical pickup 7 on the driving portion base 5. A lead screw 16a is coupled to a rotating shaft of the stepping motor 16. The lead screw 16a extends parallel to the guide shaft 8. The rack 14a engages with the lead screw 16a.

The stepping motor 16 rotates to transmit its rotating force to the rack member 14 via the lead screw 16a. Then, the optical pickup 7 moves parallel in a direction corresponding to the rotating direction of the stepping motor 16, along the guide shafts 8 and 9.

As shown in FIG. 3B, the stepping motor 16 has flat side portions 16b provided opposite each other and in a direction orthogonal to a surface of the disc 23 placed on the turntable 6a. This enables the lead screw 16a of the stepping motor 16 to be placed near the optical pickup 7, reducing the driving loss of the optical pickup 7. This in turn reduces the dimension of the disc driving portion 4 in a depth direction (vertical direction of FIG. 3B), allowing the disc drive apparatus 2 to be miniaturized. Soldering terminals 16c of the stepping motor 16 are directed toward the disc 23 to facilitate soldering to FPC.

FIG. 3C shows another form. According to this form, the flat side portions 16b of the stepping motor 16 are positioned slightly offset from the direction orthogonal to the surface of the disc 23 placed on the turntable 6a. This configuration also exerts effects similar to those of the above configuration.

A motor FPC cable 70 is connected to the disc driving motor 6 and stepping motor 16 and applied to the side of the disc driving motor 6 which is bent upward in the rotating direction. The center of the FPC cable 70 forms a loop extending substantially parallel to the rotation axis of the dist driving motor 6, and extends leftward in FIG. 3A.

As shown in FIG. 4, with the disc 23 installed on the turntable 6a, the disc driving portion 4 sandwiches the disc between itself and the clamp member 18. This is a clamp state. The optical pickup 7 lies opposite a signal recording surface of the disc 23. The FPC cable 7b is extended toward the outer periphery of the disc, formed into a loop, and applied to the rear of the driving portion base 5. The extension 7d of the presser member 7c, placed in the optical pickup 7, suppresses displacement of the FPC cable 7b toward the disc. This prevents the FPC cable 7b from coming into contact with the disc 23.

As shown in FIGS. 3A and 4, dampers 17 are attached to substantially four corners of the driving portion base 5. Each damper 17 is attached with screws 21 to a damper base 22 provided on a bottom surface of the driving portion base 5.

FIG. 5 shows the disc driving portion 4 as viewed from its back surface. As shown in FIGS. 4 and 5, a leaf spring 22i is attached to an attachment portion 22j of the damper base 22. Bosses 22a and 22d are fixed to the damper base 22. The bosses 22a and 22d engage with a cam slider 47 described below to move the disc driving portion 4. The leaf spring 22i is elastic and makes it possible to vary the height positions of abutting portions 22f, 22g, and 22h formed in the damper base 22, with respect to the bosses 22a and 22d.

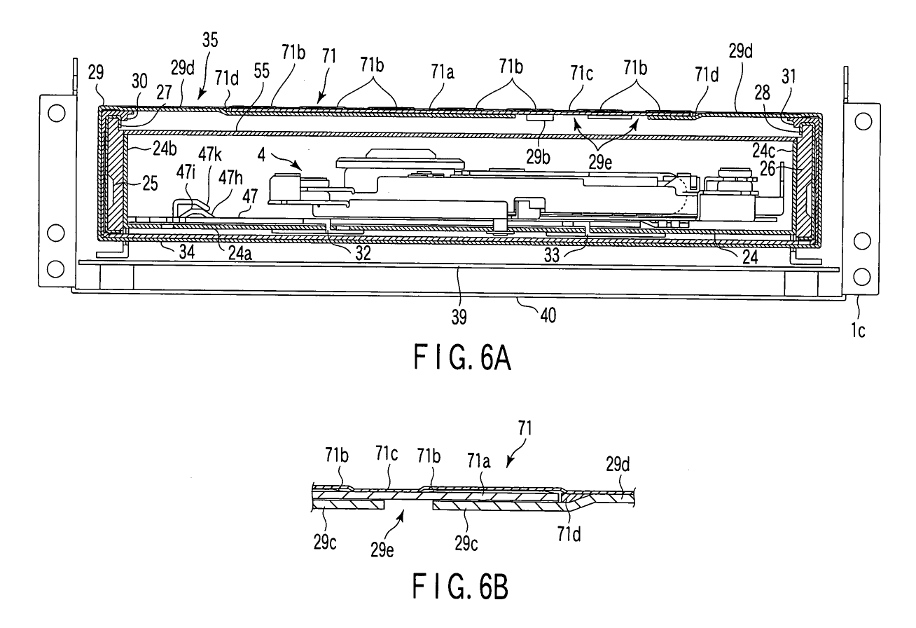

FIG. 6A shows a sectional view of the disc drive apparatus 2 as viewed from the front surface 2a. FIG. 6B is a partly enlarged view of FIG. 6A. As described below, the disc driving device 2 comprises a fixed portion fixed to the outer housing 1c of the display apparatus 1 in which the disc driving portion 4 and other driving mechanisms are mounted, and a collapsible portion 35 that is movable with respect to the fixed portion. The collapsible portion 35 is retractably supported.

The fixed portion has a base member 24, base guides 25 and 26, and a base top 55 and is shaped almost like a prism. The fixed portion functions as an attachment base that directly or indirectly supports various parts. A main circuit board 39 is placed on a bottom surface of the base member 24, and the main circuit board 39 constitutes a control portion that controls the operation of the whole device. A circuit board cover 40 is placed on a bottom surface of the main circuit board 39. The circuit board cover 40 is fixed to the base member 24. The circuit board cover 40 is attached to the outer housing 1c of the display apparatus 1.

The base member 24 has a reference plane 24a shaped almost like a flat rectangular plate, and a left bent portion 24b and a right bent portion 24c which are formed upright at a left side edge and a right side edge of the reference plane 24a so as to constitute side walls. A base top 55 is attached to the top of the left and right folded portions 24b and 24c and lies opposite the reference plane 24a. Base guides 25 and 26 are fixed to outer surfaces of the folded portions 24b and 24c, respectively. Slider guides 27 and 28 are mounted on the outside of the base guides 25 and 26, respectively. Front top guides 30 and 31 constituting a part of the collapsible portion are mounted on the outside of the slider guides 27 and 28, respectively. A disc loading mechanism holding the disc 23 and a clamp member driving mechanism are arranged on the base top 55, and the disc loading mechanism and the clamp member driving mechanism will be described below. A cam slider 47 serving as a cam member is disposed on a top surface of reference plane 24a of the base member 24. The disc driving portion 4 is movably attached to a top surface of the cam slider 47. A left arm 32 and a right arm 33 described below are provided on a bottom surface of the reference plane 24a.

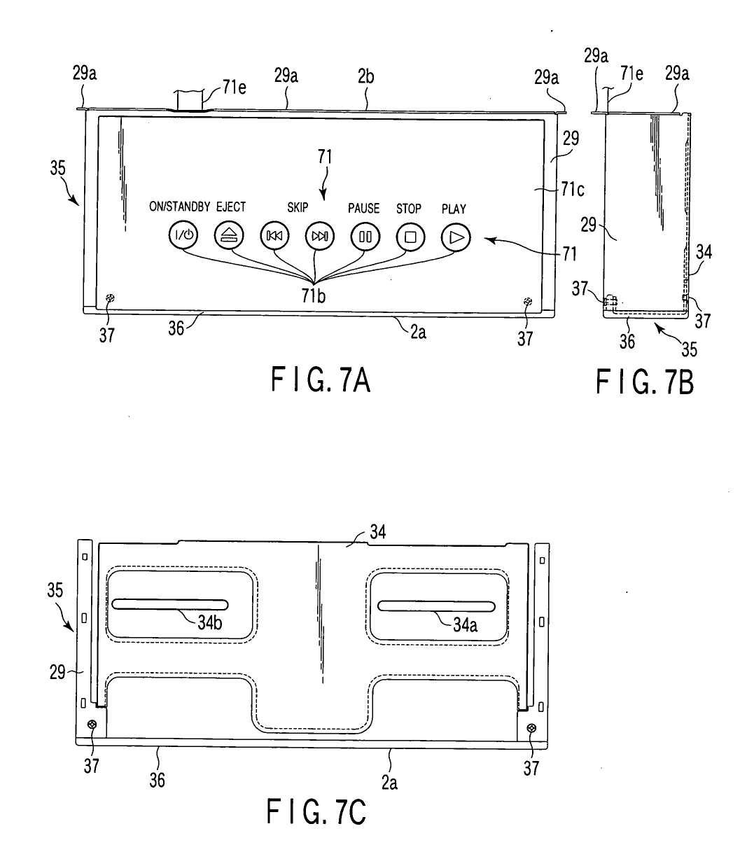

FIGS. 7A, 7B, and 7C are a plan view, a right side view, and a bottom view of the collapsible portion 35. As shown in FIGS. 6, 7A, 7B, and 7C, the collapsible portion 35 has a front top 29 that covers a top surface, sides, and a partial back surface of the fixed portion, a front bottom 34 that covers a bottom surface of the fixed portion, and a front panel 36 that covers a front surface of the fixed portion. The front top 29, front bottom 34, and front panel 36 are fixed together with screws 37 from the top surface and back surface. The retractable portion 35 is thus shaped like a flat rectangular box with an open back surface. A disc insertion port 3 is formed in the front panel 36 so that the disc 23 can be inserted and discharged through the disc insertion port 3.

Front top guides 30 and 31 are fixed to the front top 29. The slider guides 27 and 28 and the front top guides 30 and 31 are supported on the base guides 25 and 26, the fixed portion, so as to be each slidable toward the front surface of the disc drive apparatus 2. The slider guides 27 and 28, front top guides 30 and 31, base guides 25 and 26 constitute a slide support mechanism.

As shown in FIGS. 6A and 6B and 7A, 7B, and 7C, an operation key portion 71 is provided on a top surface of the front top 29 to allow the disc drive apparatus 2 to be set for a predetermined operation state or a stop state. The operation key portion 71 comprises an operation key circuit board 71a fixed to a recess portion 29c formed in the top surface of the front top 29, a plurality of switch portions 71b mounted on the operation key circuit board, an attachment base 71d that bridges the gap between the recess portion 29c and the operation key circuit board 71a, and a switch cover 71c that covers these components. Notch portions 29e are formed in the front top 29 by cutting away the recess portion 29c and a part of a top surface portion 29d. The gap between the front top 29 and the base top 55 is enlarged in the areas in the notch portions 29e are formed. Parts located opposite the base top 55 and which need to be thicker are placed outside the moving range of the recess portion 29c; these parts include a cam portion 29b provided on a back surface of top surface portion 29b of the front top 29. This enables the thickness of the whole device to be reduced.

The rear end edges of top surface and sides of the front top 29 are folded outward almost at the right angles to constitute a front top bent portion 29a. The front top bent portion 29a increases the strength of the front top 29 and can prevent dust from flowing over the top surface of the front top 29 into the drive device.

Grooves 34a and 34b extending in the lateral direction of FIG. 7C are formed in a back surface of the front bottom 34. A cable 71e extends from the collapsible portion 35 toward a rear surface 2b of the disc drive apparatus 2 to transmit signals from the operation key circuit board 71a.

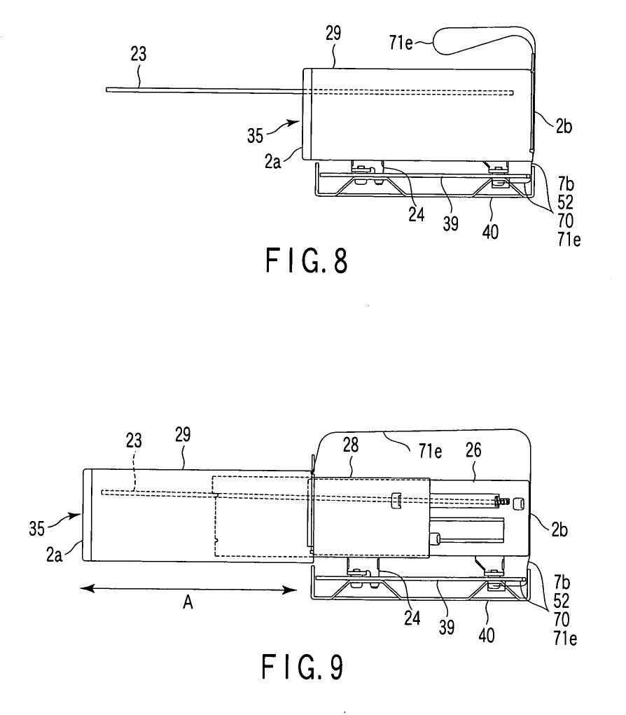

FIG. 8 is a right side view showing that the collapsible portion 35 has moved to a retracted position to cover the fixed portion and is housed in the outer housing 1c of the display apparatus. The cable 71e and a signal cable described below are connected to the main circuit board 39 from the rear surface of the disc drive apparatus 2, and signals from the operation keys are transmitted through the cable 71e.

FIG. 9 is a right side view showing that the collapsible portion 35 is extended and moved to an extended position to project from the front surface of outer housing 1c of the display apparatus 1. The slider guide 28 engaged with the base guide 26 slides over about half of the length in an extending direction A. The collapsible portion 35 slides all over the length in the extending direction. In this case, the operation key portion 71 of the front top 29, which has not been exposed in the retracted state, is exposed when the collapsible portion 35 is extended. The disc drive apparatus 2 can then be externally operated.

In the state shown in FIG. 9, the disc 23 inserted through the insertion port in the collapsible portion 35 located at the retracted position shown in FIG. 8 has been moved downward along a disc rotation axis by a predetermined amount so as to be mounted in the disc driving portion 4. However, the disc has not been moved in the extending direction A of the collapsible portion 35.

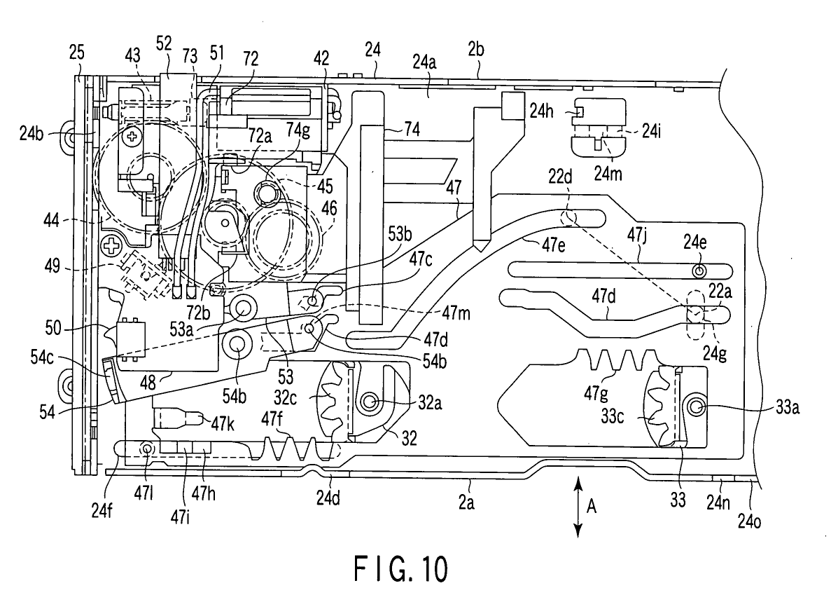

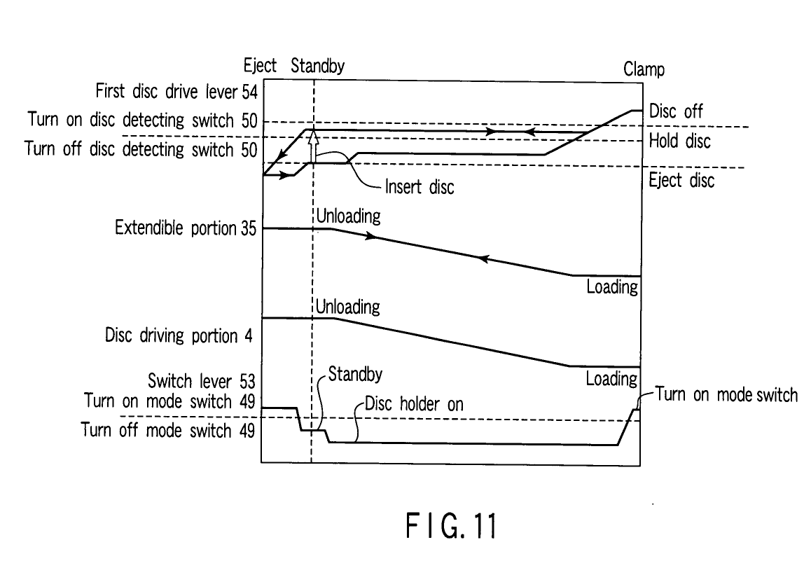

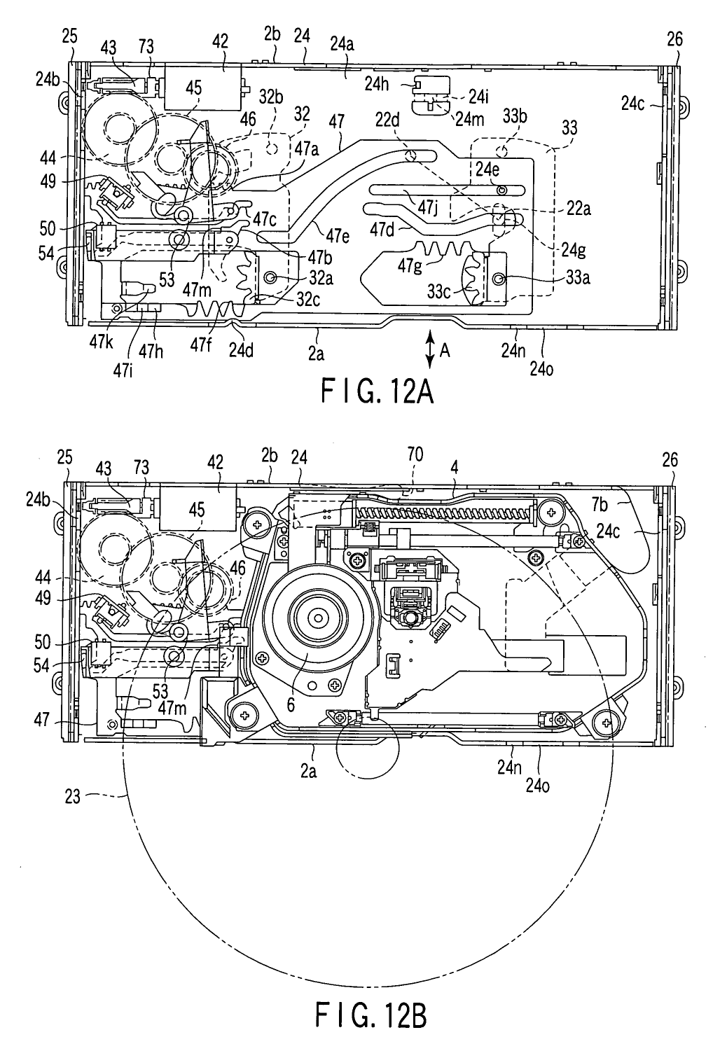

Now, a driving system for the disc drive apparatus 2 will be described. FIGS. 10, 12A, and 12B show an essential part of a driving portion provided on the base member 24 of the fixed portion. FIG. 10 shows a steady state in which the collapsible portion 35 has been retracted to enable disc insertion. FIG. 12A shows a standby state after disc insertion. FIG. 12B corresponds to the state shown in FIG. 12A and in which the disc 23 and the disc driving portion 4 have been mounted.

A mode motor 42 threadably fitted on a bracket motor 72 is attached to the base member 24. A worm 43 is attached to a rotating shaft of the mode motor 42 via a connector 73. The worm 43 engages with gears 44, 45, and 46. A plate-shaped cam slider 47 is provided on the base member 24. The cam slider 47 has a rack portion 47a that engages with the gear 46, and cam portions 47b, 47c, 47d, and 47e and gear portions 47f and 47g which drive a lever and the like described below. A boss portion 24e and a groove portion 24f provided on the base member 24 engage with a groove portion 47j and a boss portion 47l on the cam slider 47 to enable the cam slider 47 to move in the lateral direction of FIGS. 10 and 12A. The mode motor 42 rotationally drives the gar 46 to drive the cam slider 47 in the lateral direction of the figures. The lever and the like are thus driven.

A switch circuit board 48 is provided on the base member 24. A mode switch 49 and a disc detecting switch 50 are mounted on the switch circuit board 48. A cable 51 to the mode motor 42 is also connected to the switch circuit board 48. The disc detecting switch 50, constituting a detecting portion, senses when the disc 23 is inserted into a predetermined portion, to perform a switching portion. The switch circuit board 48 is connected via an FFC cable 52 to the main circuit board 39, located on the bottom surface of the base member 24.

A switch lever 53 and a first disc drive lever 54 are provided on the base member 24 so as to be rotatable around respective rotating centers 53a and 54a. The mode switch 49 is turned on and off by rotating it around the rotating center 53a of the switch lever 53. The disc detecting switch 50 is turned on and off by rotating it around the rotating center 54a of the first disc drive lever 54, which functions as a medium detecting member. Pins 53b and 54b provided on the switch lever 53 and first disc drive lever 54, respectively, engage with the cam portions 47c and 47d of the cam slider 47. Movement of the cam slider 47 rotates the switch lever 53 and first disc drive lever 54 to turn on or off the mode switch 49 and disc detecting switch 50, respectively.

The switch lever 53 rotates to drive a disc holder 74 described below. The first disc drive lever 54 has a boss 54c provided opposite the pin 54b across the rotating center 54a. As described below, the boss 54c engages with levers of the disc loading mechanism placed on the base top 55 of the fixed portion. Insertion of the disc 23 rotates the first disc drive lever 54 to turn on the disc detecting switch 50.

The cam portion 47b of the cam slider 47 engaged with the pin 54b of the first disc drive lever 54 is formed to be wide; the first disc drive lever 54 functions as an engaging portion. Thus, the first disc drive lever 54 is rotatable while the cam slider 47 is located in its initial position. The first disc drive lever 54 is thus movable to a state in which it turns on the disc detecting switch 50 as shown in FIGS. 12A and 12B and to a state in which it turns off the disc detecting switch 50 as shown in FIG. 10. This corresponds to an arrangement in which disc insertion turns on the disc detecting switch 50. Movement of the cam slider 47 rotates the first disc drive lever 54 to turn off the disc detecting switch 50 so as to allow the disc to be discharged.

The boss 22a of the damper base 22, shown in FIG. 4, engages with the cam portion 47d of the cam slider 47 and a guide portion 24g of the base member 24 as shown in FIGS. 10 and 12A. The boss 22d of the damper base 22 engages with the cam portion 47e of the cam slider 47. The bosses 22a and 22d project from the bottom surface of the base member 24. Lumilers 22b are attached to leading ends of the bosses 22a and 22d. In this state, the leaf spring 22i is flexed to bias the damper base 22 toward the reference plane 24a of the base member 24. While the collapsible portion 35 is retracted, that is, in the standby state, the disc driving portion 4 is housed in the base member 24.

The guide portion 24g of the base member 24 comprises a groove extending in the same direction as the extending direction A of the collapsible portion 35, which is the vertical direction of FIG. 10. Rightward movement of the cam slider 47 starts moving the boss 22a in the same direction as the extending direction A along the cam shape of the cam portion 47d. The boss 22d moves along the cam shape of the cam portion 47e. Thus, a disc driving portion driving mechanism is composed of the mode motor 42, and the worm 43, gears 44 to 46, and cam slider 47, which transmit the rotation of the mode motor. The disc driving portion driving mechanism moves the disc driving portion 4 toward the front surface 2a of the disc drive apparatus 2.

The left arm 32 and right arm 33 are provided on the bottom surface of reference plane 24a of the base member 24 to serve as an arm portion that controls extension and retraction of the collapsible portion 35. The left arm 32 and right arm 33 have pivot supporting portions 32a and 33a at their base ends and bosses 32b and 32b projected from their leading ends; the pivot supporting portions 32a and 33a are supported on the base member 24, and the bosses 32a and 32b engage with the collapsible portion 35. The bosses 32b and 33b project away from the reference plane 24a and engage with the grooves 34a and 34b, formed in the front bottom 34 of the collapsible portion 35, shown in FIG. 7C. The grooves 34a and 34b extend in a direction orthogonal to the extending and retracting direction A. Gear portions 32c and 33c are formed on the left arm 32 and right arm 33, respectively, so as to project toward the reference plane 24a. The gear portions 32c and 33c can engage with the gear portions 47f and 47g, respectively, of the cam slider 47.

In the retracted state shown in FIGS. 12A and 12B, the bosses 32b and 33b are positioned closer to the rear end of the base member 24 than the rotating centers 32a and 33a of the left arm 32 and right arm 33. This moves the collapsible portion 35 to the retracted position.

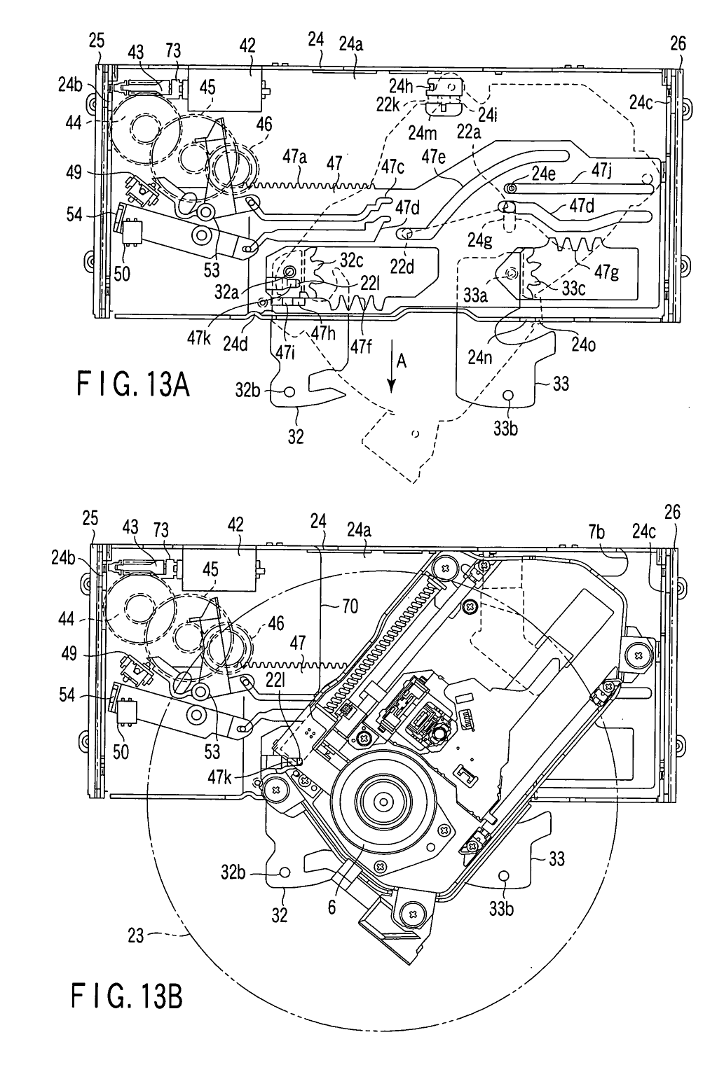

Moving the cam slider 47 rightward in the retracted state shown in FIGS. 12A and 12B, engages the gear portions 32c and 33c with the gear portions 47f and 47g to drive the gear portions 32c and 33c. Thus, as shown in FIGS. 13A and 13B, the left arm 32 rotates counterclockwise, while the right arm 33 rotates clockwise. The collapsible portion 35 is driven by the left arm and right arm to move in the extending direction A. The collapsible portion 35 thus changes to the extended state. The left arm 32, the right arm 33, and the cam slider 47 driving these arms constitute an extension and retraction driving portion. An extension and retraction driving mechanism is composed of the mode motor 42, and the worm 43, gears 44 to 46, and extension and retraction driving portion, which transmit the rotation of the mode motor 42.

As shown in FIG. 12B, in the standby state, the FPC cable 7b to the optical pickup 7 is applied to the side of the driving portion base 5. The center axis of the FPC cable 7b forms a loop substantially parallel to the rotating shaft of the disc drive motor 6. The FPC cable 7b is extended leftward and upward in the figure and is then connected to the main circuit board 39, placed on the bottom surface of the base member 24. The motor FPC cable 70 is also applied to the side of the driving portion base 5. The center axis of the motor FPC cable 70 forms a loop substantially parallel to the rotating shaft of the disc drive motor 6. The motor FPC cable 70 is extended leftward in the figure and is then connected to the main circuit board 39, placed on the bottom surface of the base member 24.

FIG. 11 is a timing chart showing changes in the operation state of the device in conjunction with the movement of the cam slider 47. When the cam slider 47 moves rightward in the standby state in which the disc can be inserted, as shown in FIG. 12A, the standby state changes to the disc clamp state. The cam portion 47b of the cam slider 47, controlling the first disc drive lever 54, forms a wide cam groove while the collapsible portion 35 is being extended. During the extension of the collapsible portion 35, displacement of the disc 23 in the extending direction A of the collapsible portion 35 rotates a first inner disc lever 59 described below. This rotating is transmitted to a second disc drive lever 60 and the first disc drive lever 54. This turns off the disc detecting switch. Thus, to prevent improper clamping of the disc 23 to the disc driving portion 4, the control portion stops the extension of the collapsible portion 35 and changes to a disc discharge mode.

The change to the clamp state changes the first disc drive lever 54 from a disc hold state to a disc off state. The change from the standby state to the clamp state changes the collapsible portion 35 to the extended state. This moves the disc driving portion 4 in the extending direction A of the collapsible portion 35 to align the rotating center of the disc driving motor 6 with the rotating center of the disc 23.

To discharge the disc 23, the clamp state changes to the eject state. This change is made by moving the cam slider 46 leftward. The first disc drive lever 54, collapsible portion 35, and disc driving portion 4 perform operations opposite to those performed to change from the standby state to the clamp state. When the standby state changes to the eject state, the cam slider 47 ejects the disc in the extending direction of the collapsible portion 35 by a predetermined amount. This facilitates the removal of the disc 23. Further, to allow for the next disc insertion, the eject state changes to the standby state.

The mode switch 49 is off in the standby state and turns on immediately before the clamp state. This brakes the mode motor 42, which is stopped in the clamp state. To allow the disc 23 to be discharged, the mode switch 49 turns on when the standby state changes to the eject state. Thus, a given time later, the mode motor 42 is braked and stopped in the eject state and then immediately changes to the standby state. At this time, the mode switch 49 turns off to brake and stop the mode motor 42 in the standby state.

FIG. 13A is a plan view showing the driving portion on the base member 24. The figure shows the clamp state in which the collapsible portion 35 has been extended to enable recording and reproducing operations to be performed on the disc. FIG. 13B corresponds to the state shown in FIG. 13A and in which the disc and the disc driving portion have been mounted.

The switch lever 53 engages with the cam portion 47c of the cam slider 47, and the mode switch 49 remains on. The first disc drive lever 54 has changed from a hold state describe below to the disc off state.

The disc driving portion 4 moves and rotates the collapsible portion 35 in the extending direction A. This aligns the rotating center of the disc driving motor 6 with the rotating center of the disc 23; the rotating center of the disc driving motor 6 has been located offset, by a predetermined amount, from the substantially laterally central portion of the disc drive apparatus 2. In manual insertion, the position of the disc 23 where the disc detecting switch 50 is turned on or off during manual insertion is substantially the same as the position where the disc 23 is mounted in the disc driving portion 4.

A protruding cam portion 24m of the fixed portion is projected from the reference plane 24a of the base member 24 up to a predetermined height. A protruding cam portion 24o is formed in a front bent portion of the base member 24 so as to have a predetermined height. Tapered portions 24l and 24n are formed at clockwise positions with respect to the boss 22a of the damper base 22. The tapered portions 24l and 24n extend so as to decline gently from the protruding cam portions 24m and 24o toward the reference plane 24a. In the operation position shown in FIG. 12B, the disc driving portion 4 does not contact the protruding cam portion 24m or 24o. However, as the operation position changes to the one shown in FIG. 13B, the disc driving portion 4 rotates counterclockwise around the center of the boss 22a of the damper base 22. Then, the abutting portions 22f and 22g of the damper base 22, shown in FIG. 5, are raised by the tapered portions 24l and 24n and run on to the protruding cam portions 24m and 24o.

As shown in FIGS. 6A and 6B, a protruding cam portion 47i is projected from the cam slider 47 up to a predetermined height. A tapered portion 47h is formed to the right of the protruding cam portion in the figure so as to decline gently from the protruding cam portion 47i toward the reference plane 24a of the base member 24. In the operation position shown in FIG. 12B, the disc driving portion 4 does not contact the protruding cam portion 47i. However, as the operation position changes to the one shown in FIG. 13B, the abutting portions 22h of the damper base 22 is raised along the tapered portion 47h and run on to the protruding cam portion 47i. Thus, the disc driving portion 4 is moved toward the disc 23 in its axial direction only in the clamp state. This reduces the difference between the insertion height of the disc and the height of the disc mounted on the turntable 6a of the disc driving motor 6. This in turn improves the reliability of operations of clamping and unclamping the disc 23.

A positioning device for the disc driving portion 4 will be described. The disc driving portion 4 is moved by moving the cam slider 47 rightward from its initial position and driving the bosses 22a and 22b of the damper base 22 along the cam shape of the cam portions 47d and 47e of the cam slider 47. A locking portion 24h is formed on the base member 24. In the position in the clamp state shown in FIG. 13A, the cam shape of the cam portions 47d and 47e of the cam slider 47 causes a locking portion 24k at an end of the damper base 22 to be pressed against the locking portion 22h. On this occasion, the leaf spring 22i of the damper base 22 functions as a biasing member. A key-shaped positioning corner portion 47k shown in FIG. 6A is formed on the cam slider 47. In the position in the clamp state shown in FIG. 13A, a positioning hole 22l formed in the damper base 22 engages with the positioning corner portion 47k. Thus, the disc driving portion 4 is positioned by the locking portion 24h of the base member 24 and the positioning corner portion 47k of the cam slider 47. This improves the positional accuracy of the turntable 6a and the effect of insulating vibration of the turntable 6a.

As shown in FIGS. 13A and 13B, the left arm 32 and right arm 33, arranged on the bottom surface of the reference plane 24a of the base member 24, have rotated through substantially 180° from their initial positions. In this case, the bosses 32a and 32b are located in front of the rotating central portions 32a and 33a of the left arm 32 and right arm 33, respectively, that is, closer to the front surface of the display apparatus 1. Thus, the collapsible portion 35 has been extended.

In the clamp state, the FPC cable 7b to the optical pickup 7 is applied to and wound around the side of the driving portion base 5. The FPC cable 7b is then formed into a loop and extended leftward in FIG. 13B. The FPC cable 7b is further connected to the main circuit board 39, placed on the bottom surface of the base member 24. The motor FPC cable 70 is applied to the side of the driving portion base 5 to form an open loop. The motor FPC cable 70 is extended upward in FIG. 13B and then connected to the main circuit board 39, placed on the bottom surface of the base member 24. Thus, the FPC cable 7b and motor FPC cable 70 are arranged so that their central axes form loops substantially parallel to the rotating shaft of the disc driving motor 6, all over the area in which the disc driving portion 4 moves between the standby state and the clamp state. The FPC cable 7b and motor FPC cable 70 also move within a plane parallel to the plane on which the disc driving portion 4 moves.

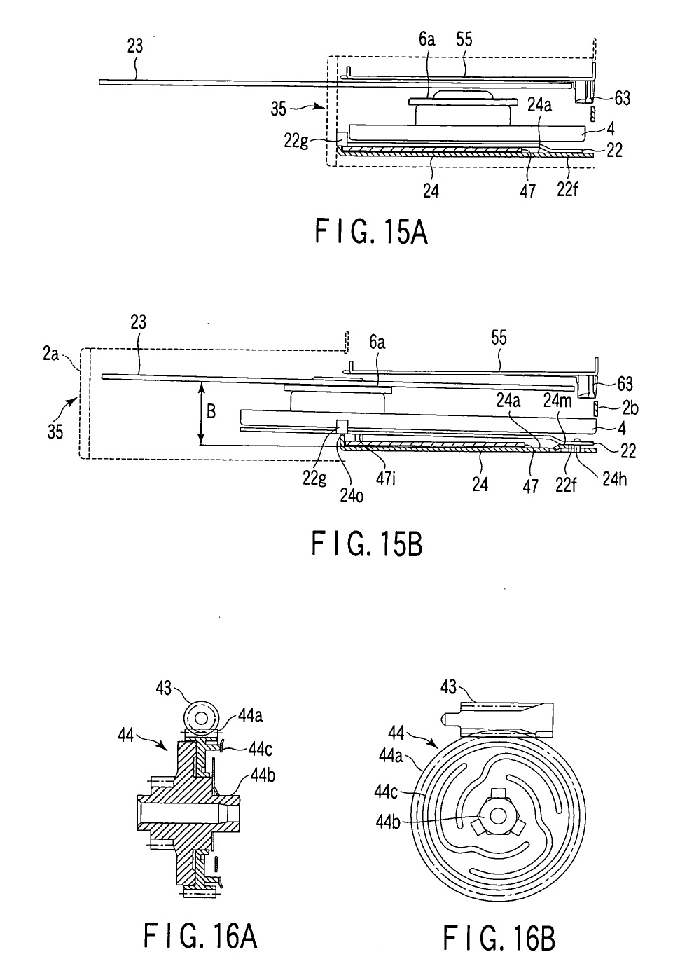

FIGS. 15A and 15B are sectional views of essential parts of the standby state shown in FIG. 12B and of the clamp state shown in FIG. 13B as viewed from the right. In the standby state shown in FIG. 15A, the placement surface of turntable 6a of the disc driving portion 4 is parallel to the reference plane 24a of the base member 24. In contrast, in the clamp state shown in FIG. 15B, the placement surface of the turntable 6a has moved toward the disc 23. The disc driving portion 4 is inclined at about a predetermined angle B to the reference plane 24a of the base member 24 so as to run on to the protruding cam portions 24m and 24o of the base member 24 and to the protruding cam portion 47i of the cam slider 47 to locate the front surface 2a of the disc drive apparatus 2 higher. The placement surface of the turntable 6a in the clamp state is thus inclined to the placement surface of the turntable 6a in the standby state to enable a reduction in twisting of the motor FPC cable 70 and the FPC cable 7b to the optical pickup 7. This makes it possible to prevent the cables from being damaged. A gap can also be created between the disc 23 and a disc detecting stopper 63 provided on the rear surface 2b-side top surface of the disc drive apparatus 2.

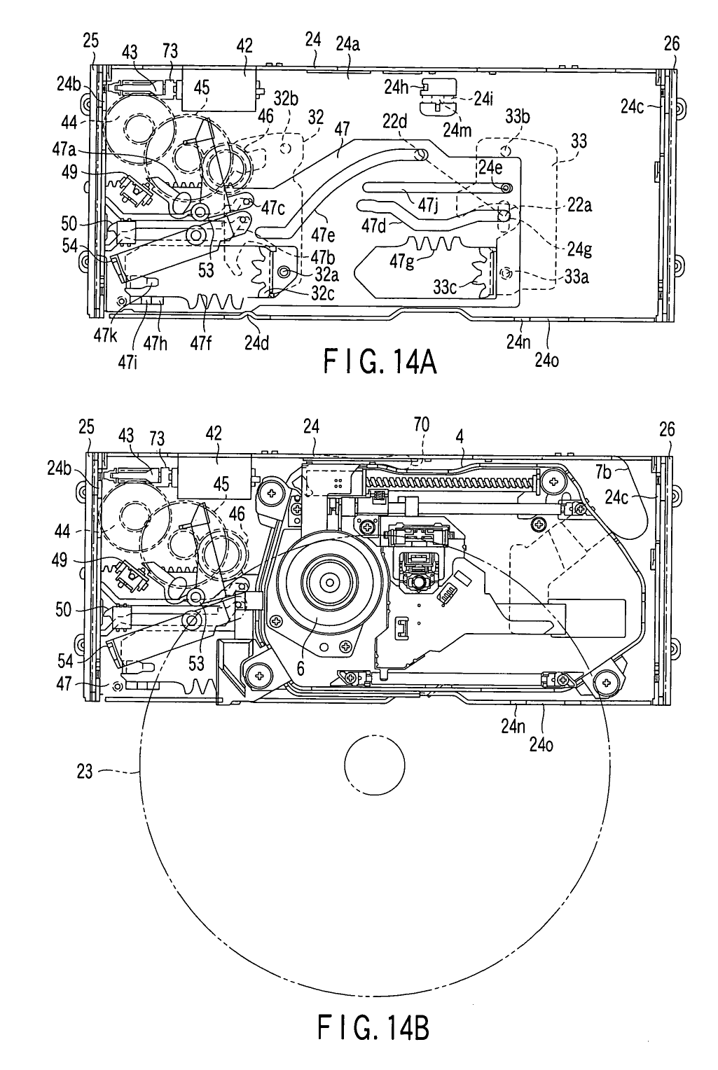

FIGS. 14A and 14B are plan views showing the driving portion on the base member 24. FIG. 14A shows the eject state in which the collapsible portion 35 has been moved to the retracted position. FIG. 14B corresponds to the state shown in FIG. 14A and in which the disc and the disc driving portion 4 have been mounted.

The cam slider 47 has moved leftward from the clamp state to the eject state. The switch lever 53 engages with the cam portion 47c of the cam slider 47. The mode switch 49 is kept on by the switch lever 53. The first disc drive lever 54 has changed from a disc hold state described below to the disc eject state. In this case, the first disc drive lever 54 is separated from the disc detecting switch 50, which is thus turned off. A changed to the standby state enables the next disc insertion. The disc driving portion 4 has been moved in the retracting direction of the collapsible portion 35 and housed in the base member 24.

Movement of the cam slider 47 has rotated the left arm 32 and right arm 33 from the clamp state to the standby state in the opposite directions through substantially 180°. The bosses 32b and 33b are positioned closer to the rear end of the fixed portion than the rotating central portions 32a and 33a of the left arm 32 and right arm 33. The collapsible portion 35 has been moved in the retracting direction by the left arm 32 and right arm 33 and located in the retracted position.

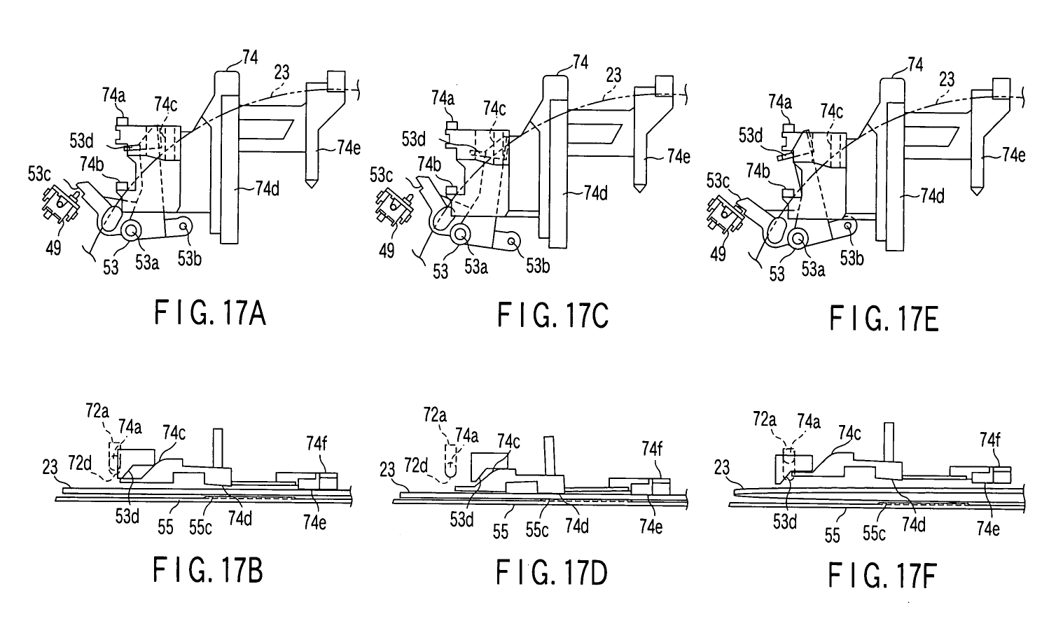

Now, description will be given of a structure that sandwiches the disc while the collapsible portion 35 is in operation. FIGS. 17A to 17E shows how the disc holder 74 is switched by a switch lever 53. The switch lever 53 has a cam portion 53d closer to the rear surface 2b of the disc drive apparatus 2 than the rotating center 53a. The switch lever 53 has three angular positions, a standby angular position, a disc holder on angular position, and a mode switch on angular position, as shown in FIGS. 17A to 17E to set three states of the disc holder 74; the thee angular positions are set via the cam portion 47c of the cam slider 47. FIGS. 17A and 17B show the standby angular position. FIGS. 17C and 17D show the disc holder on angular position. FIGS. 17E and 17F show the mode switch on angular position. FIGS. 17B, 17D, and 17F are side views of an essential part as viewed from the rear surface 2b of the disc drive apparatus 2. The cam slider 47 and switch lever 53 constitute a holder driving mechanism that drives the disc holder 74.

The disc holder 74 is positioned between the disc 23 and the switch lever 53 and has bosses 74a and 74b. As shown in FIG. 10, the bosses 74a and 74b engage with grooves 72a and 72b in the bracket motor 72. The grooves 72a and 72b in the bracket motor 72 are shaped like elongate grooves. The bosses 74a and 74b can move in the direction of rotation axis of the disc 23 along the grooves 72a and 72b by a predetermined amount. A cam 74c is formed in the disc holder 74 and located opposite the cam portion 53d of the switch lever 53. A disc sandwiching portion 74d and a guide portion 74e are also formed on the disc holder 74. A rubber member or the like having a large friction coefficient is fixed to the disc sandwiching portion 74d in order to sandwich the disc 23.

As shown in FIGS. 17A and 17B, in the standby angular position of the switch lever 53, the disc holder 74 is held in the standby position. A stopper portion 74f of the disc holder 74 abuts against a stopper abutting portion (not shown) of the disc driving portion 4. The guide portion 74e is placed in proximity to the disc 23 to be inserted. The guide portion 74e guides the disc 23 during disc insertion. During disc insertion, the disc sandwiching portion 74d is spaced from the guide portion 74e so as not to abut against the disc.

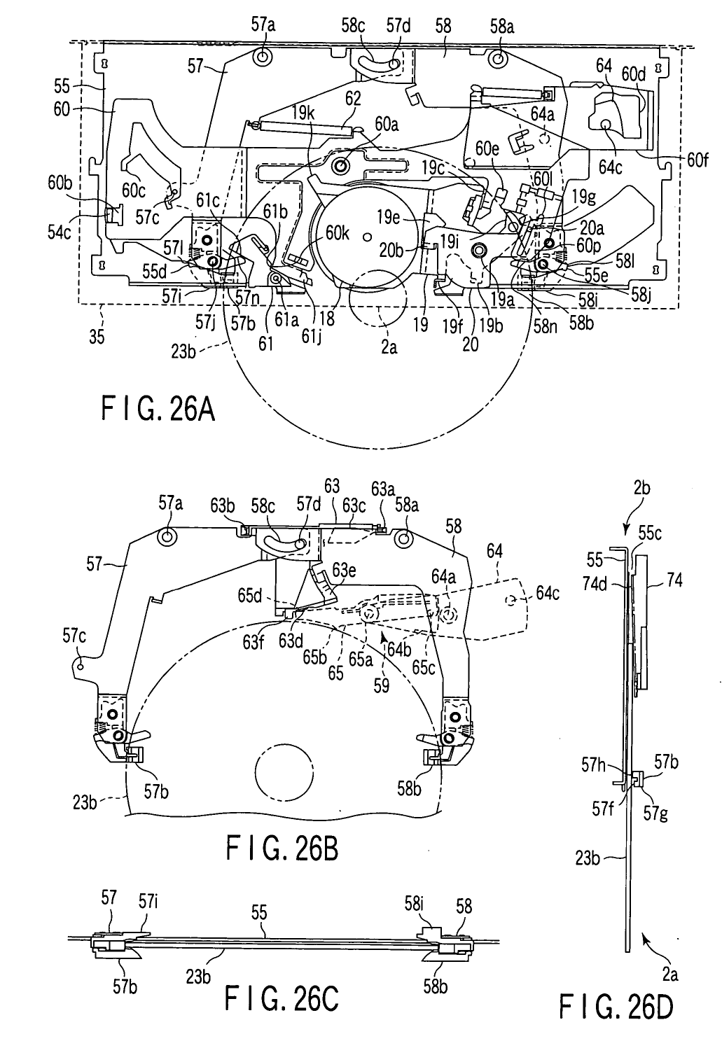

FIGS. 17C and 17D show that during a change from the standby state to the clamp state, the collapsible portion 35 is moving. During this time, the switch lever 53 rotates to the disc holder on angular position, while the disc holder 74 is moved to the hold position. The switch lever 53 rotates clockwise from the standby angular position, shown in FIG. 17A, to the disc holder on angular position. This rotating causes the cam portion 53d of the switch lever 53 to push the disc sandwiching portion 74d toward the disc 23. The bosses 74a and 74b of the disc holder 74 thus abut against disc-side terminals ?74d and 74e? of the grooves 72a and 72b. The disc sandwiching portion 74d abuts against the disc 23. The disc 23 is sandwiched and held between the disc abutting portion 55c of the base top 55 and the disc sandwiching portion 74d. This prevents the inserted disc 23 from being displaced while the collapsible portion 35 is in operation. In this case, as shown in FIG. 26D, an abutting surface of the disc sandwiching portion 74d is inclined away from the disc 23 and toward the inner periphery of the disc. The disc sandwiching portion 74d abuts firmly against only an outer peripheral portion of the disc 23.

As shown in FIGS. 17E and 17F, in the clamp state, the switch lever 53 rotates counterclockwise from the standby angular position to the mode switch on angular position. This rotating allows the cam portion 53d of the switch lever 53 to stop pushing the disc sandwiching portion 74d toward the disc 23. Movement of the disc driving portion 4 separates the stopper portion 74f of the disc holder 74 from the stopper abutting portion of the disc driving portion 4. This moves the disc holder 74 to the on position and is located far away from the disc 23. As shown in FIG. 10, a spring member 74g is attached to the disc holder 55. One end of the spring member 74g abuts against the base top 55 to slightly bias the disc holder 74 away from the disc 23. Thus, as shown in FIG. 17F, the disc holder 74 is spaced from the disc 23.

As described above, while the collapsible portion 35 is in operation, the disc holder 74 installs the disc 23 along the rotation axis of the disc to prevent the inserted disc from being displaced during the extension of the collapsible portion 35. This makes it possible to reduce failures to clamp the disc 23. In the clamp state, the disc holder 74 is retracted from the disc 23 to ensure a gap between itself and the rotating disc.

FIGS. 16A and 16B are a plan view and a sectional view showing the worm 43 and gear 44 of the driving portion. The gear 44 has a large gear 44a that engages with the worm 43, a small gear 44b that engages with a large gear of the gear 45, and a bias gear 44c. The large gear 44a and small gear 44b are concentric and rotatable and constitute a clutch mechanism based on the pushing force of the bias spring 44c. A clutch force is set at a predetermined value exceeding a normal load on the driving portion. When a strong external force is exerted on the collapsible portion 35 while it is in operation, a strong force is applied to the extension and retraction driving mechanism, particularly to the left arm 32 and right arm 33 of the extension and retraction driving mechanism. However, the clutch mechanism of the gear 44 enables this external force to escape, making it possible to prevent damage to the extension and retraction driving mechanism.

The extending and retracting operations of the collapsible portion 35 shown in FIGS. 12B to 13B and 14B enable the standby state to be set while the disc drive apparatus 2 is unused. The collapsible portion 35 is thus held in the retracted position, where it covers the fixed portion. This makes it possible to reduce the depth dimension of the disc drive apparatus 2. To allow the disc drive apparatus 2 to operate, the clamp state is set to extend the collapsible portion 35 to provide a housing portion for the disc 23. Further, the disc driving portion 4 moves to the driving position to allow information to be read from or written to the disc 23. To eject the disc, an operation opposite to the extending operation of the collapsible portion 35 is performed to change from the standby state through the eject state back to the standby state. Thus, in the extending and retracting direction A of the collapsible portion 35, the clamp state is located in one direction, while the eject state is located in the other direction, with respect to the standby state. This allows the disc to be inserted and removed using the simple configuration.

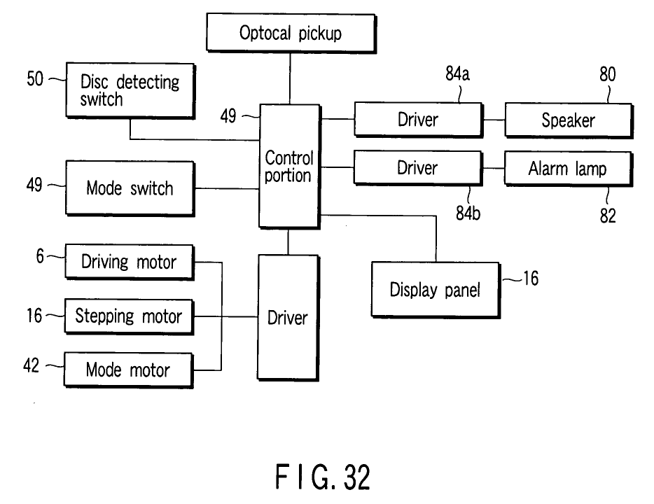

Now, description will be given of an alarm device that operates when the disc is inserted. When the disc 23 is inserted into the disc drive apparatus 2 through the insertion port 3, the collapsible portion 35 extends so as to cover the disc. At this time, the collapsible portion 35 may abut against an operator's hand inserting the disc 23, and the operator may have a sense of discomfort. Thus, as shown in FIG. 32, the disc drive apparatus 2 comprises a sound generating device functioning as an alarm device, for example, a speaker 80 and a light emitting device, for example, a LED or an alarm lamp 82. These devices are connected to the main circuit board 39, the control portion, via drivers 84a and 84b. The speaker 80 may be provided independently of the disc drive apparatus 2 or a speaker of the display apparatus 1 in which the disc drive apparatus is mounted. The alarm lamp 82 is provided, for example, all over the surface of the disc drive apparatus 2. Alternatively, the alarm device may be the image display panel 1b of the display apparatus 1.

Inserting the disc 23 to turn on the disc detecting switch 50 causes the main circuit board 39 to operate the speaker 80 to generate an alarm sound. A sound can also be generated by operating the speaker of the display apparatus 1. The main circuit board 39 may illuminate the alarm lamp 82 to alarm the operator, in response to operation of the disc detecting switch 50 resulting from disc insertion. Alternatively, the display panel 1b of the display apparatus 1 may show that the disc 23 has been inserted. This allows the operator to be aurally or visually informed of the disc insertion. This in turn makes it possible to improve a sense of operation and to prevent a possible danger when the collapsible portion 35 moves to the extended position.

Now, description will be given of a runaway preventing device for the collapsible portion 35. As shown in FIGS. 10 and 12A, the cam portion 47b of the slider 47, provided on the base member 24, has a lock portion 47m formed of a step portion. FIG. 10 shows that the disc 23 has not been inserted and that the first disc drive lever 54 is located in the illustrated standby position (first position). On this occasion, a pin 54b of the first disc drive lever 54 is positioned so as to be engageable with the lock portion 47m. The pin 54b thus restricts the rightward movement, in the figure, of the cam slider 47. In contrast, FIG. 12 shows that the disc 23 has been inserted. The first disc drive lever 54 has been rotated clockwise via a disc loading mechanism described below and located in the illustrated sensing position. The pin 54b has been moved in the cam portion 47b and located in a released position where it is removed from the lock portion 47m. This allows the cam slider 47 to be unlocked by the pin 54b and to move rightward in the figure.

As described above, the cam slider 47 can move rightward to extend the collapsible portion 35 only when the disc 23 is inserted. This prevents the situation in which malfunction of the control system for the mode motor 42 or vibration causes the cam slider 47 to move inadvertently to extend the collapsible portion 35 with the disc not inserted. Reliability can thus be improved.

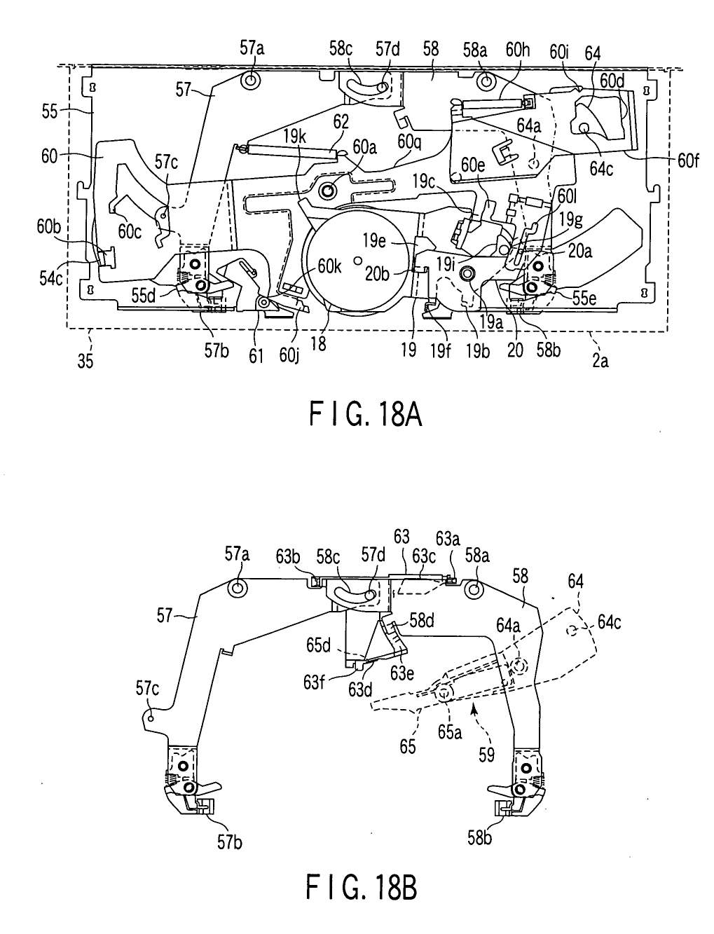

Now, description will be given of the disc loading mechanism that installs the disc 23 on the disc driving portion 4. FIG. 18A shows the disc loading mechanism and clamp member driving mechanism provided on the base top 55, positioned above the base member 24. FIG. 18B shows an essential part of the state shown in FIG. 18A. The base top 55 is shaped like a substantially flat plate having substantially the same size as that of the reference plane 24a of the base member 24. The base top 55 is fixed on the left and right folded portions 24b and 24c via the base guides 25 and 26 and lies almost parallel to and opposite the reference plane 24a.

The disc loading mechanism comprises a left disc lever 57 and a right disc lever 58 which hold the disc 23 inserted through the disc insertion port 3 in the collapsible portion 35. The left disc lever 57 has a rotating central portion 57a supported on the base top 55 and a disc holding portion 57b positioned close to the front surface 2a of the disc drive apparatus 2. Pins 57c and 57d are fixed on the left disc lever 57.

The right disc lever 58 has a rotating central portion 58a supported on the base top 55 and a disc holding portion 58b positioned close to the front surface 2a of the disc drive apparatus 2. A cam groove 58c is formed in the right disc lever 58. The pin 57d of the left disc lever 57 always engages with the cam groove 58c. This allows the disc holding portion 57b of the left disc lever 57 and the disc holding portion 58b of the right disc lever 58 to operate substantially laterally symmetrically with respect to the central portion of the base top 55.

The inner disc lever 59, which detects the inserted disc 23, comprises a first inner disc lever 64 functioning as a first disc detecting lever and a second inner disc lever 65 functioning as a second disc detecting lever. The first inner disc lever 64 has a rotating central portion 64a rotatably supported on the right disc lever 58 and a pin 64c formed at a right end in the figure. The second inner disc lever 65 has a rotating central portion 65a rotatably supported at a left end of the first inner disc lever 64. The second inner disc lever 65 is rotatable with respect to the first inner disc lever 64.

The second disc drive lever 60 has a rotating central portion 60a supported on the base top 55, a groove portion 60b that engages with the boss 54c of the first disc drive lever 54, shown in FIG. 10, a cam groove 60c that drives the pin 57c of the left disc lever 57, and a groove portion 60d that engages with the pin 64c of the inner disc lever 59.

A tension spring 62 is installed between the left disc lever 57 and the second disc drive lever 60. The tension spring 62 biases the left disc lever 57, right disc lever 58, and second inner disc lever 64 so that the disc holding portions 57b and 58b and a disc abutting portion (first abutting portion) 65b of the second inner disc lever 64 can rotate toward the substantial center of the inserted disc 23. The disc loading mechanism is composed of the left disc lever 57, right disc lever 58, inner disc lever 59, second disc drive lever 60, and tension spring 62. Further, the disc loading mechanism constitutes the disc detecting mechanism together with the first disc drive lever 54 and disc detecting switch 50.

The second disc drive lever 60 comprises a lever main body 60q, a small lever 60f having a rotating central portion 60g supported on the lever main body 60q, and a spring member 60h that biases and presses the lever main body 60q and small lever 60f against a stop portion 60i. The lever main body 60q, small lever 60f, and spring member 60h normally operate integrally.

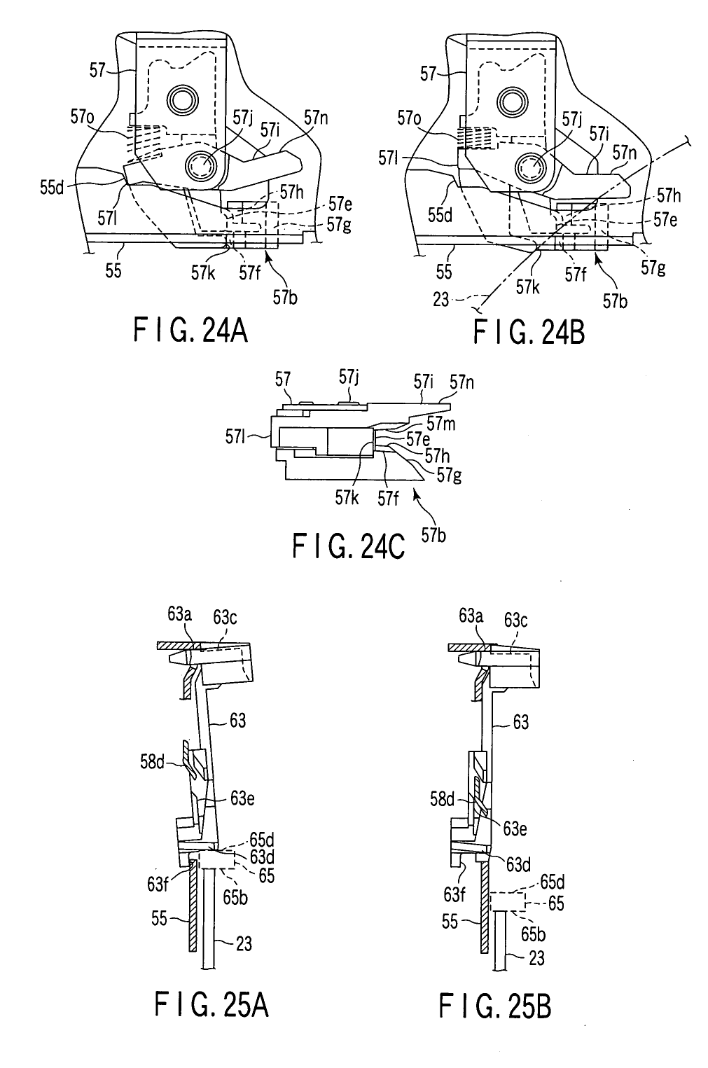

FIGS. 18A and 18B show the standby state in which disc insertion is possible. Insertion of the disc 23 of diameter 12 cm causes the outer peripheral edge of the disc 23 to push the disc holding portions 57b and 58b and the disc abutting portion 65b of the second inner disc lever 65. Consequently, the disc holding portions 57b and 58b and the disc abutting portion 65b are movable. FIG. 24A shows the disc holding portion 57b of the left disc lever 57. FIG. 24B is a side view of the disc holding portion as viewed from the front surface 2a of the disc drive apparatus 2. The disc holding portion 57b of the left disc lever 57 has a disc abutting portion 57e that abuts against the outer peripheral edge of the disc 23, and a tapered portion 57g. The tapered portion 57g raises the disc lowered from the clamp state by a predetermined amount for discharge, up to the disc abutting portion 57e; in the clamp state, the disc is installed on the disc driving motor 6.

The disc holding portion 57b comprises a left detecting lever 57i that is a disc detecting member and a spring 57o that is a spring member. The left detecting lever 57i has a rotating central portion 57j rotatably supported at a leading end of the left disc lever 57, a disc abutting portion 57k that abuts against the outer periphery of the disc 23, and a locking portion 57l. The left detecting lever 57i is biased by the spring 57o so that the disc abutting portion 57k rotates counterclockwise toward the disc center. Thus, in the state shown in FIG. 24A, the locking portion 57l engages with the locking portion 55d of the base top 55. Consequently, when a smaller-diameter disc of diameter 8 cm is inserted, the rotating of the left disc lever 57 is locked. FIG. 24C shows that insertion of the disc 23 of diameter 12 cm is started. At this time, the outer peripheral edge of the disc 23 abuts against the disc abutting portion 57k of the left detecting lever 57i, which thus rotates clockwise. This disengages the locking portion 57l from the locking portion 55d of the base top 55, enabling the left disc lever 57 to rotate clockwise. Consequently, the disc 23 of diameter 12 cm can be inserted. The disc holding portion 58b of the right disc lever 58 and the disc holding portion 57b of the left disc lever 57 operate substantially laterally symmetrically with respect to the central part of the base top 55.

The base top 55 has a disc detecting stopper 63 that prevents excessive insertion of the disc. FIGS. 25A and 15B are sectional views of essential parts of the device as viewed from its right side. These figures show two states of the disc detecting stopper 63. FIG. 25A shows the state of the disc detecting stopper 63 observed when the smaller-diameter disc 23b of diameter 8 cm is inserted. A leading end 63f of the stopper is abutting against the base top 55. The inserted smaller-diameter disc 23b abuts against the second inner disc lever 65, which abuts against a second locking portion 63d of the disc detecting stopper 63 at a predetermined position of disc insertion. This results in the state shown in FIGS. 26A, 26B, 26C, and 26D and described below.

FIG. 25B shows the state of the disc detecting stopper 63 observed during the insertion of the disc 23 of diameter 12 cm. The insertion of the disc 23 has caused the outer peripheral edge of the disc to abut against the second inner disc lever 65. The insertion of the disc 23 further rotates the left disc lever 57 clockwise and the right disc lever 58 counterclockwise and slips the cam portion 58d of the right disc lever 58 into the cam portion 63e of the disc detecting stopper 63. The disc detecting stopper 63 is attacked to the base stop 55 via pawl portions 63a and 63b so as to be rotatable around a line joining the pawl portions 63a and 63b together. Thus, the cam portion 58d of the right disc lever 58 slips into the cam portion 63e of the disc detecting stopper 63 to move the second locking portion 63d of the disc detecting stopper 63 leftward in FIG. 25B. This enables the second inner disc lever 65 to move to the position where it abuts against the first locking portion 63c of the disc detecting stopper 63.

Thus, the disc detecting stopper 63 has the two locking portions used for the insertion of the smaller-diameter disc 23b of diameter 8 cm and for the insertion of the large-diameter disc of diameter 12 cm. When the large-diameter 23 of diameter 12 cm is inserted, the second locking portion 63d used for the insertion of the smaller-diameter disc 23b of diameter 8 cm is moved to a position where it does not interfere with the insertion of the large-diameter disc 23. This enables both the large- and smaller-diameter discs to be inserted. In the clamp state, described below, the disc detecting stopper 63 is biased toward the disc outer periphery by the second inner disc lever 65 and held with a gap from the rotating disc maintained. This prevents the rotation of the disc from being hindered by the disc detecting stopper 63, allowing the disc to be smoothly rotated. The vibration insulating effect is also improved.

As shown in FIG. 18A, the clamp member driving mechanism including a clamp lever 19 is provided in the central portion of the base top 55. The clamp member driving mechanism will be described below.

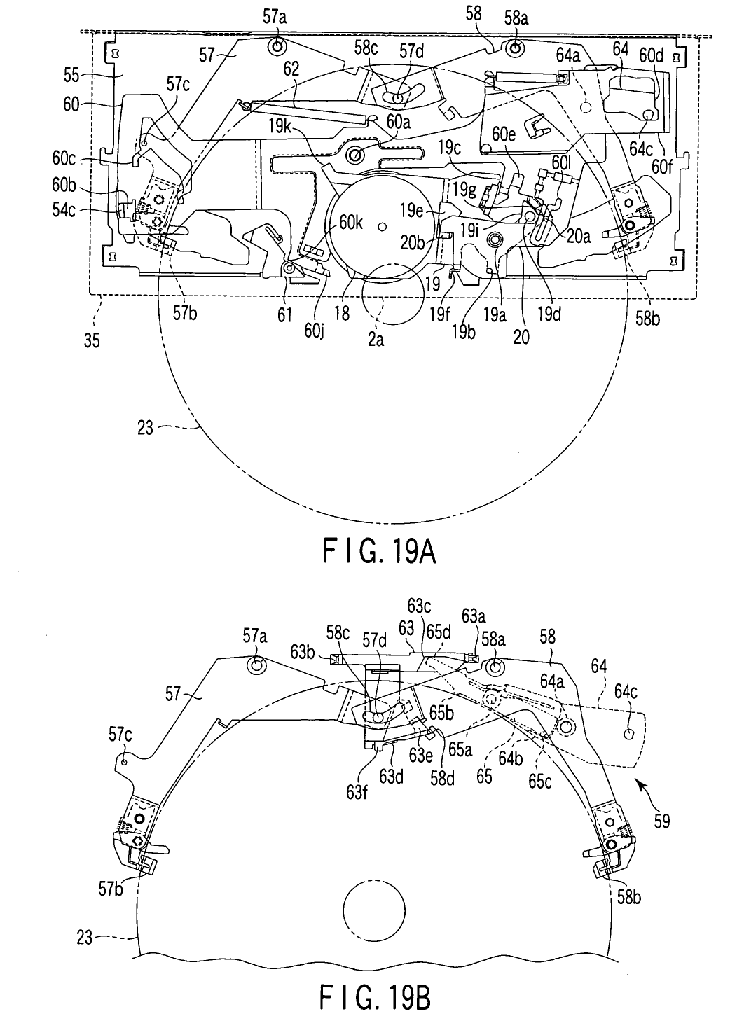

FIG. 19A shows the standby state in which the disc 23 is being inserted. The insertion of the disc 23 causes the outer peripheral edge of the disc to push the holding portion 57b of the left disc lever 57 and the holding portion 58b of the right disc lever 58 to move the holding portions 57b and 58b toward the disc outer periphery. The inner disc lever 59 is rotated together with the right disc lever 58. The disc abutting portion 65b of the inner disc lever 59 is positioned to abut against the outer peripheral edge of the disc 23. Movement of the inner disc lever 59 drives the pin 64c to push the groove 60d in the second disc drive lever 60. Then, in FIG. 19A, the second disc drive lever 60 is rotated clockwise to drive the boss 54c of the first drive lever 54. This rotates the first disc drive lever 54 to a position (intermediate position) located a predetermined amount away from the angular position where the disc detecting switch 50 is turned on, as shown in FIG. 12A.

During the insertion of the disc 23 shown in FIGS. 18A, 18B, 19A, and 19B, the disc abutting portion 65b of the second inner disc lever 65 is pushed by the outer peripheral edge of the disc 23. The second inner disc lever 65 is biased clockwise to cause the boss portion 65c to abut against the locking portion 64b of the first inner disc lever 64. This allows the first inner disc lever 64 and second inner disc lever 65 to rotate integrally to drive the stopper abutting portion (second abutting portion) 65d of the second inner disc lever 65 to a position where it abuts against the first locking portion 63c of the disc detecting stopper 63.

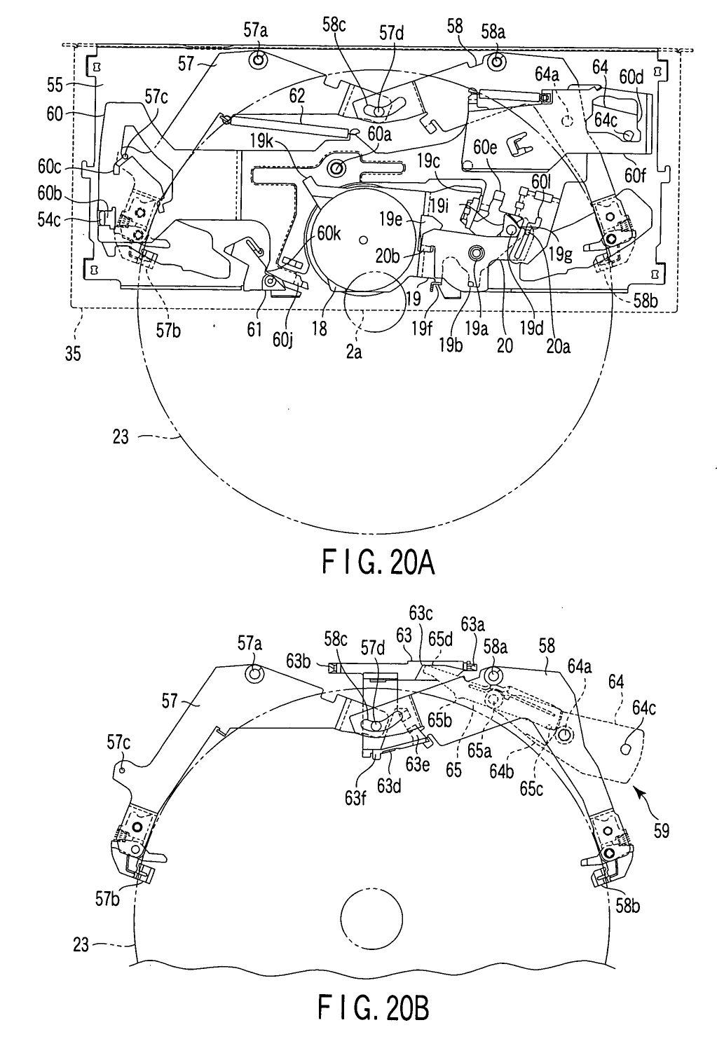

FIGS. 20A and 20B show the standby state corresponding to the state shown in FIGS. 19A and 19B and in which the disc is further inserted into the device. The further insertion of the disc 23 further rotates the inner disc lever 59 to drive the pin 64c. Thus, the groove portion 60d of the second disc drive lever 60 is further pushed. This further rotates the second disc drive lever 60 further clockwise to drive the boss 54c of the first disc drive lever 54. Thus, the first disc drive lever 54 is rotated to a predetermined angular position where the disc detecting switch 50 is turned on, that is, a detection position (second position) as shown in FIG. 12A. Switching of the disc detecting switch 50 allows the control portion to detect that the disc 23 has been inserted to the correct position. The control portion then rotates the mode motor 42 to start changing to the clamp state.

During the insertion of the disc shown in FIGS. 19A, 19B, 20A, and 20B, the disc abutting portion 65b of the second inner disc lever 65 is pushed by the outer peripheral edge of the disc 23. However, the stopper abutting portion 65d of the second inner disc lever 65 abuts against the first locking portion 63c of the disc detecting stopper 63. Thus, the second inner disc lever 65 is driven counterclockwise to separate the boss portion 65c from the locking portion 64b of the first inner disc lever 64. The rotating central portion 65a of the second disc lever 65 is thus rotated. This rotates the first inner disc lever 64 clockwise to cause the pin 64c to further push the groove portion 60d of the second disc drive lever 60. The second disc drive lever 60 is thus further rotated clockwise to the predetermined angular position where the disc detecting switch 50 is turned on.

This configuration makes it possible to increase the ratio of the rotating amount of the second disc drive lever 60 to the amount of disc insertion from the state shown in FIGS. 19A and 19B to the state shown in FIGS. 20A and 20B, above the ratio of the rotating amount of the second disc drive lever 60 to the amount of disc insertion from the state shown in FIGS. 18A and 18B to the state shown in FIGS. 19A and 19B. In other words, the displacement of the first disc drive lever 54 with respect to the disc insertion amount can be increased only in the vicinity of the position where the disc detecting switch 50 is turned on. This enables a reduction in the possibility of performing a turn-on operation in the wrong position as a result of misalignment of the disc detecting switch 50. Clamp errors can thus be reduced.

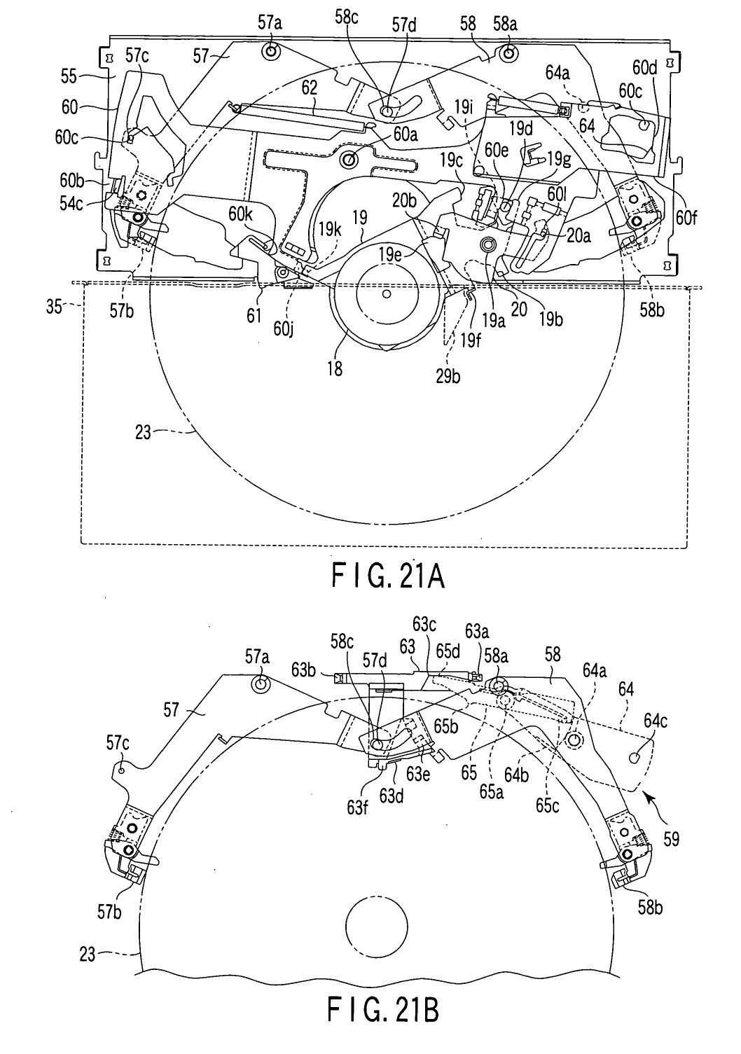

FIGS. 21A and 21B show the clamp state in which the disc 23 has been clamped by the disc loading mechanism and clamp member driving mechanism. In this state, the first disc lever 54 is rotated clockwise from the standby position. The second disc drive lever 60 is also rotated clockwise. The pin 57c, provided on the left disc lever 57, is thus driven by the cam groove 60c in the second disc drive lever 60 to rotate the disc holding portion 57b of the left disc lever 57 in the direction in which it leaves the disc 23. The disc holding portion 58b of the right disc lever 58 is rotated in synchronism with the left disc lever 57 in the direction in which it leaves the disc 23.

The inner disc lever 59 is rotated together with the right disc lever 58 to push the pin 64c in the groove portion 60d of the second disc drive lever 60. The second disc lever 65 thus rotates counterclockwise to separate the disc abutting portion 65b from the disc 23. At the same time, the disc detecting stopper 63 is biased toward the disc outer periphery by the second inner disc lever 65. This makes it possible to prevent the disc holding portions 57b and 58b and disc abutting portion 65b from interfering with the rotation of the disc mounted on the disc driving motor 6.

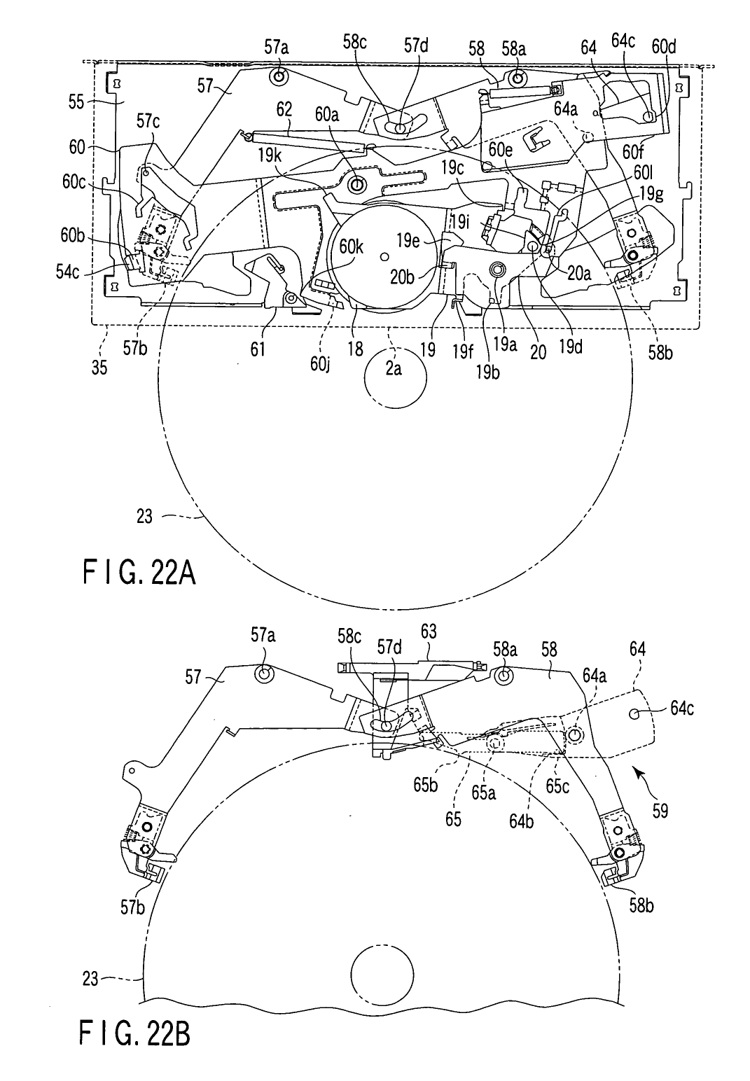

FIGS. 22A and 22B show the eject state in which the disc loading mechanism and clamp member driving mechanism have discharged the disc. The first disc drive lever 54 and second disc drive lever 60 are each rotated counterclockwise. The pin 64c is thus pushed in the groove portion 60d of the second disc drive lever 60 to rotate the inner disc lever 59. The disc abutting portion 65b urges and discharges the disc 23. This facilitates removal of the disc 23. To be inserted again, the discharged disc 23 is pushed in as it is after the change to the standby state. This enables disc insertion.

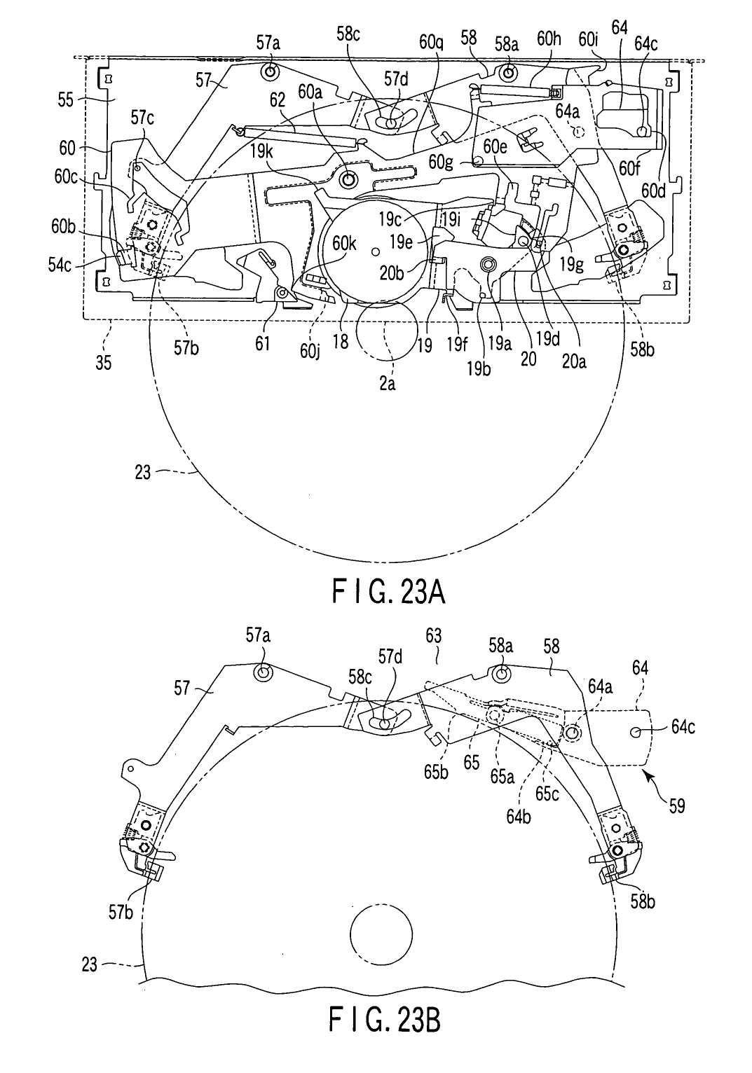

FIGS. 23A and 23B correspond to the eject state shown in FIGS. 22A and 22B and in which the discharged disc 23 is forcibly pushed in. In this case, the inner disc lever 59 is pushed in by the disc 23. The pin 64c then pushes in the groove portion 60d of the second disc drive lever 60. Here, the second disc drive lever 60 comprises a lever main body 60q, a small lever 60f having a rotating central portion 60g on the lever main body 60q, and a spring member 60h that biases and urges the lever main body 60q and small lever 60f against the stop portion 60i. Thus, the small lever 60f rotates around the rotating central portion 60g to extend the spring member 60h and thus leaves the stop portion 60i. Thus, the normally integrally operating second disc drive lever 60 is provided with the spring member 60h. Forcibly pushing the disc 23 deforms the spring member 60h to move only the small lever 60f. This absorbs an excessive load acting on the disc loading mechanism, making it possible to avoid damage to the disc loading mechanism.

FIG. 26A shows the disc loading mechanism and clamp member driving mechanism, provided on the base stop 55. In this figure, the smaller-diameter disc 23b of diameter 8 cm is inserted in the standby state. FIG. 26B shows an essential part of the state shown in FIG. 26A. FIG. 26C shows a side view of the essential part as viewed from the front surface 2a of the disc drive apparatus 2. Before insertion of the smaller-diameter disc 23b, the locking portion 57l of disc holding portion 57b of the left disc lever 57 is engaged with the locking portion 55d of the base top 55. The locking portion 58l of disc holding portion 58b of the left disc lever 58 is engaged with the locking portion 55e of the base top 55. The disc holding portion 57b of the left disc lever 57 and the disc holding portion 58b of the left disc lever 58 can thus restrict the lateral position of the smaller-diameter disc 23b. This enables the smaller-diameter disc 23b to be positioned during a change to the clamp state. In this case, as shown in FIG. 26C, the smaller-diameter disc 23b is held at a predetermined height.

Insertion of the smaller-diameter disc 23b causes the smaller-diameter disc to push in the disc abutting portion 65b of the second inner disc lever 65. The stopper abutting portion 65d abuts against the second locking portion 63d of the disc detecting stopper 63. Further insertion of the smaller-diameter disc 23b further rotates the inner disc lever 59 to drive the pin 64c. The second disc drive lever 60 is further pushed in via the groove portion 60d. This further rotates the second disc drive lever 60 clockwise to drive the boss 54c of the first disc drive lever 54. The first disc drive lever 54 is thus rotated to the predetermined angular position where the disc detecting switch 50 is turned on as shown in FIG. 12A. Switching of the disc detecting switch 50 allows the detection of insertion of the disc 23 to the correct position. The control portion then rotates the mode motor 42 to start changing to the clamp state.

During the insertion of the disc 23b, the disc abutting portion 65b of the second inner disc lever 65 is pushed by the outer peripheral edge of the disc 23b. However, the stopper abutting portion 65d of the second inner disc lever 65 abuts against the second locking portion 63d of the disc detecting stopper 63. Thus, the second inner disc lever 65 is driven counterclockwise to separate the boss portion 65c from the locking portion 64b of the first inner disc lever 64. The rotating central portion 65a of the second disc lever 65 is thus rotated. This rotates the first inner disc lever 64 clockwise to cause the pin 64c to further push the groove portion 60d of the second disc drive lever 60. The second disc drive lever 60 is thus further rotated clockwise to the predetermined angular position where the disc detecting switch 50 is turned on.

FIG. 26D is a side view of an essential part of the state shown in FIG. 26B as viewed from the right. The figure shows that the collapsible portion 35 is moving. In this case, the disc sandwiching portion 74d of the disc holder 74 presses the part of the smaller-diameter disc 23b which is closer to the rear surface 2b of the disc drive apparatus 2, against the disc abutting portion 55c of the base stop 55 to restrict the height of the disc. The laterally central part of the smaller-diameter disc 23b thus has its height restricted by the disc holding portion 57b of the left disc lever 57 and the disc holding portion 58b of the right disc lever 58.

Here, the abutting surface of the disc sandwiching portion 74d is inclined away from the disc 23d toward the disc inner periphery. The disc sandwiching portion 74d abuts firmly against only the outer peripheral part of the disc 23. Further, the left and right disc holding portions 57b and 58b each have a disc bottom surface abutting portion 57h at their U-shaped leading end as shown in FIGS. 24A, 24B, and 24C. The disc bottom surface abutting portion 57h is formed to be thin and has elasticity acting across the thickness of the disc. The gap between the disc bottom surface abutting portion 57h and a disc top surface abutting portion 57m is set slightly smaller than the standard disc thickness. When the disc is inserted, the disc bottom surface abutting portion 57h is bent and lowered to bias the top surface of the disc to the disc top surface abutting portion 57m to restrict the height of the disc.

Restrictions are thus made on the height of that part of the disc which is closer to the rear surface 2b of the disc drive apparatus and on the height of laterally central portion of the disc. Accordingly, the posture of the smaller-diameter disc 23b is determined by the top surface criterion for the disc. This makes it possible to eliminate a variation in disc posture resulting from a variation in disc thickness. The disc bottom surface abutting portion 57h with the elastic structure enables a reduction of a variation in the height (lateral direction of FIG. 26D) of the disc on its side closer to the front surface 2a. This prevents the smaller-diameter disc 23b from coming into contact with parts in the device while the collapsible portion 35 is in move or interfering with the disc insertion port 3.

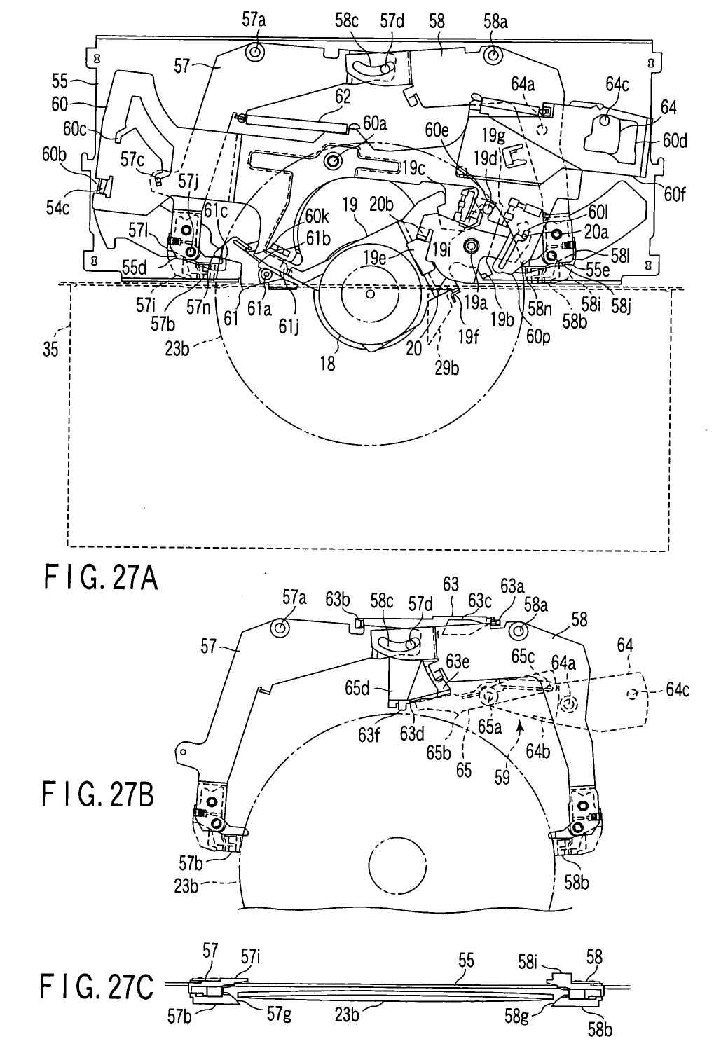

FIG. 27A shows the disc loading mechanism and clamp member driving mechanism in the clamp state in which the smaller-diameter disc 23b has been inserted. FIG. 27B shows an essential part of FIG. 27A. FIG. 27C is a side view of the essential part as viewed from the front surface 2a of the disc drive apparatus 2.

In this case, the first disc drive lever 54 and second disc drive lever 60 are each rotated clockwise. The pin 57c of the left disc lever 57 is thus driven by the cam groove 60c in the second disc drive lever 60 to rotate the disc holding portion 57b of the left disc lever 57 away from the smaller-diameter disc 23b. The right disc lever 58 rotates in synchronism with the left disc lever 57 in the direction in which the disc holding portion 58b leaves the smaller-diameter disc 23b.

In this case, the locking portion 57l of disc holding portion 57b is engaged with the locking portion 55d of the base top 55. The locking portion 58l of disc holding portion 58b of the right disc lever 58 is engaged with the locking portion 55e of the base top 55. These components need to be disengaged from one another. During a change from the state shown in FIGS. 26A, 26B, 26C, and 26D to the state shown in FIGS. 27A, 27B, and 27C, the second disc drive lever 60 is rotated clockwise. At a first stage of this rotating, the engagement is removed from the locking portion 571 of disc holding portion 57b of the left disc lever 57 and from the locking portion 58l of disc holding portion 58b of the right disc lever 58. At a second stage, the disc holding portion 57b of the left disc lever 57 and the disc holding portion 58b of the right disc lever 58 are rotated away from the smaller-diameter disc 23b.

During the disengagement of the locking portion 57l at the first stage, the cam portion 60k of the second disc drive lever 60 pushes in a third disc drive lever 61. The third disc drive lever 61 has a rotating central portion 61a provided on the base top 55 and rotates counterclockwise in response to the push-in of the cam portion 61b. A leading end 61c of the third disc drive lever 61 then pushes in a leading end 57n of the left detecting lever 57i, provided on the disc holding portion 57b of the left disc lever 57. The left detecting lever 57i thus rotates clockwise to enable disengagement from the locking portion 55b of the base top 55. At the first stage, the cam portion 60p of the second disc drive lever 60 pushes in a leading end 58n of the right detecting lever 58i, provided on the disc holding portion 58b of the right disc lever 58. The right detecting lever 58i thus rotates counterclockwise. As a result, the locking portion 58l of disc holding portion 58b of the right disc lever 58 is disengaged from the locking portion 55e of the base top 55.

The inner disc lever 59 is rotated together with the right disc lever 58 to push the pin 64c in the groove portion 60d of the second disc drive lever 60. The disc abutting portion 65b thus rotates away from the smaller-diameter disc 23b. At this time, the disc detecting stopper 63 is biased toward the disc outer periphery by the second inner disc lever 65. Thus, the disc holding portions 57b and 58b and the disc abutting portion 65b can be held at positions where they do not hinder the rotation of the smaller-diameter disc 23b mounted on the disc driving motor 6. On this occasion, as shown in FIG. 27C, the smaller-diameter disc 23b is mounted on the turntable 6a of the disc driving motor 6 (not shown) and held lower than the position shown in FIG. 26C, by a predetermined amount. Consequently, during a change to the eject state, the disc 23b is held at a height to which the disc can be raised, by the tapered portions 57g and 58g of the disc holding portions 57b and 58b.

With the above configuration, in the standby state, the disc loading mechanism can restrict the lateral position of the smaller-diameter disc 23b. During a change to the clamp state, the disc loading mechanism can position the smaller-diameter disc 23b. This makes it possible to prevent clamp errors, and in the clamp state, to prevent the hindrance of rotation of the smaller-diameter disc 23b mounted on the disc driving motor 6.

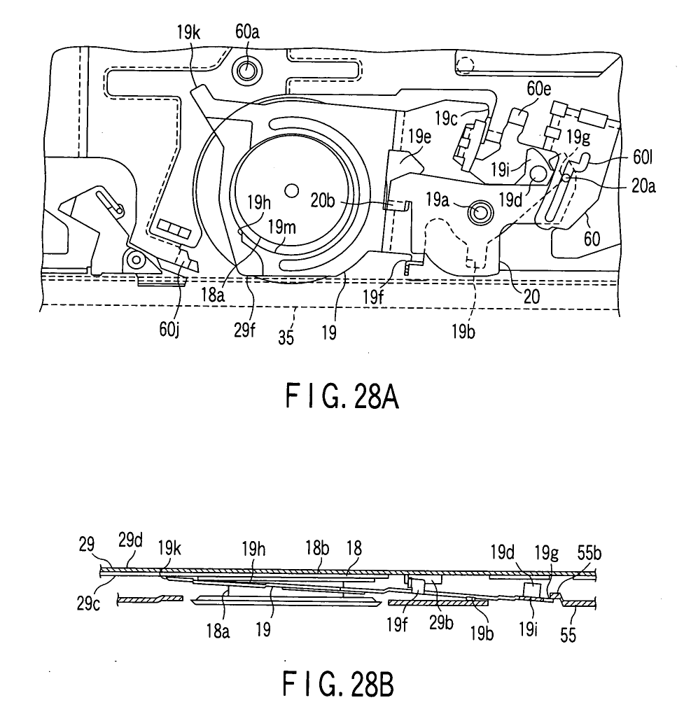

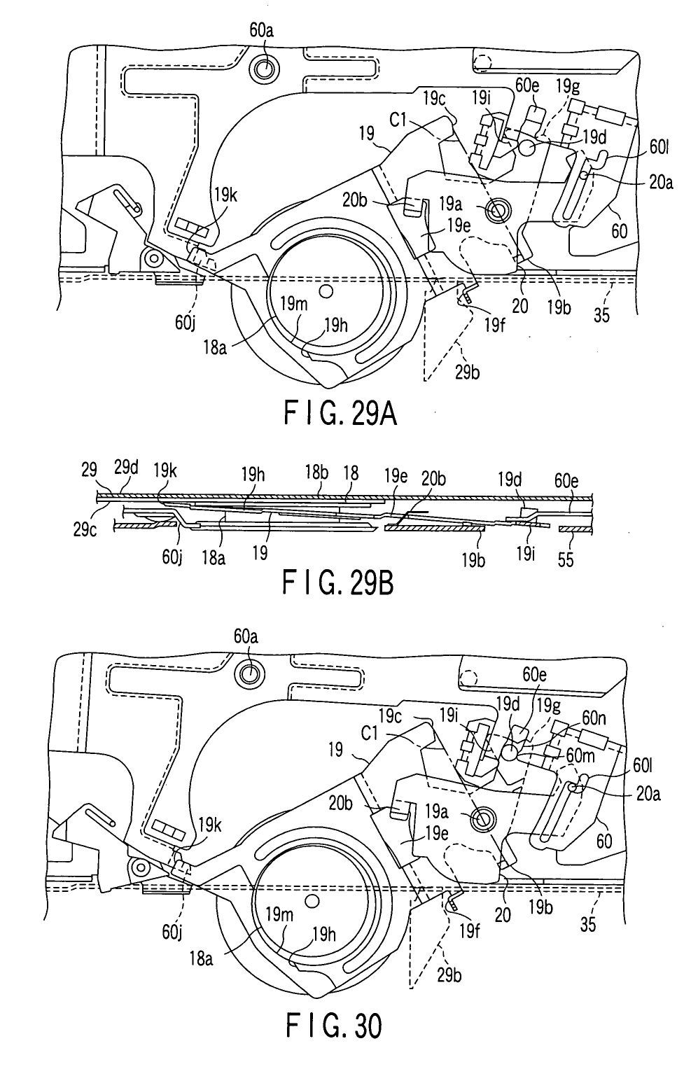

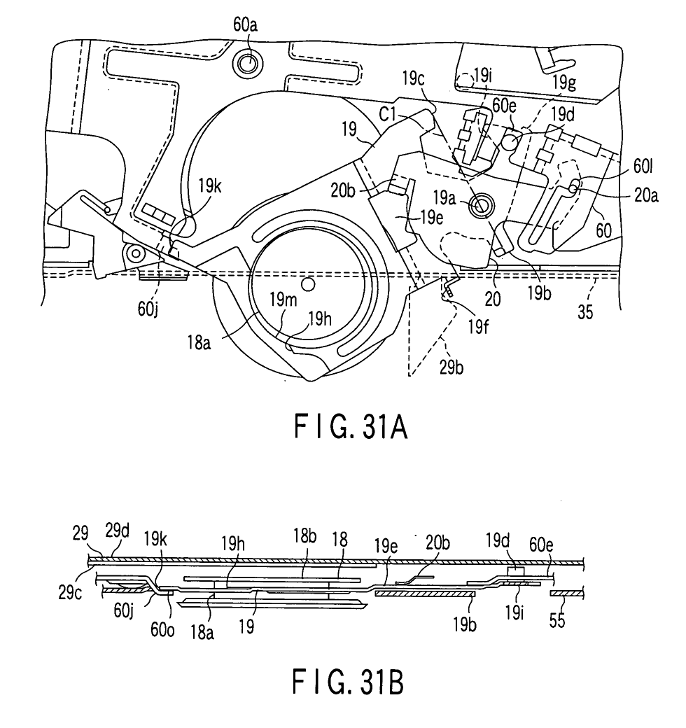

Now, the clamp member driving mechanism will be described. As shown in FIG. 18A, the clamp member driving mechanism including the clamp lever 19 is provided in the central part of the base top 55. FIGS. 28A, 28B, 29A, 29B, 30, 31A, and 31B show an essential part of the clamp member driving mechanism from which an upper clamp member 18b of the clamp member 18 has been removed. FIGS. 28A to 31B are schematic diagrams illustrating the operation of the clamp member driving mechanism as viewed from the front surface 2a of the disc drive apparatus 2. FIGS. 28A and 28B shows the standby state corresponding to FIG. 20A. FIGS. 31A and 31B shows the clamp state corresponding to FIG. 21A. FIGS. 29A, 29B, and 30 show the intermediate state between FIGS. 28A and 31A.

The clamp lever 19 is two-dimensionally rotatable around the rotating central portion 19a. The clamp member 18 is rotatably supported in a hole portion 19m at one end of the clamp lever 19. The clamp lever 19 abuts against the base top 55 via a protruding portion 19b provided on its bottom surface at one end with respect to the rotating central portion 19a and via the other end 19c. The clamp member 18 can move up and down around a line C1 (see FIG. 29A) joining the protruding portion 19b and the end 19c. A pin 19d is fixed to the clamp lever 19.

A spring member 20 having a spring portion 20b at one end is attached to the rotating central portion 19a of the clamp lever 19 so as to be rotatable around the rotating central portion 19a. The spring member 20 has a pin 20a formed at the other end and engaging with a groove 60l in the second disc drive lever 60. In this case, the spring portion 20b of the spring member 20 slips into the hole portion 19e of the clamp lever 19 so as not to abut against the clamp lever 19. The spring portion 20b thus does not hinder an abutting portion 19h of the clamp lever 19 described below from raising the clamp member 18 upward.

The second disc drive lever 60 has a cam groove 60e through which pins 19d and 19k of the clamp lever 19 are driven, a cam portion 60j, and the cam groove 60l that drives the pin 20a of the spring member 20 is driven.

The cam groove 60e, cam portion 60j, and cam groove 60l of the second disc drive lever 60 constitute a clamp lever driving portion. The second disc drive lever 60, clamp lever 19, and spring member 20 constitute the clamp member driving mechanism. In the standby state shown in FIGS. 28A and 28B, the clamp lever 19 is pushed in the front bent portion 29f of the front top 29 and positioned in the outer shape of the base top 55. In this case, the clamp lever 19 abuts against the top surface of the base top 55 via the protruding portion 19b and end 19c. A projecting portion 19g abuts against a back surface of the cam portion 55b of the base top 55. This allows the abutting portion 19h of the clamp lever 19 to raise the clamp member 18 upward. The clamp member 18 is thus pressed against the front top 29 of the collapsible portion 35, which corresponds to a raised position where it does not hinder disc insertion.

The change from FIG. 28A to FIG. 29A extends the collapsible portion 35 to allow the cam portion 29b, provided on the back side of the top surface portion 29d of the front top 29, to push in the protruding portion 19f of the clamp lever 19. The clamp lever 19 rotates two-dimensionally around the rotating central portion 19a. This rotating causes a suction portion 19i of the clamp lever 19 to slip onto the bottom surface of the cam groove 60e in the second disc drive lever 60. The pin 19d is rotated to a position where it can engage with the cam groove 60e in the second disc drive lever 60. At this time, the cam portion 55b, which regulates the projecting portion 19g, is shaped not to be formed on the projecting portion 19g. A change to the state shown in FIGS. 30 and 31A allows the projecting portion 19g to rise.

In FIG. 31A, the second disc drive lever 60 changes to the clamp state. On this occasion, rotating of the second disc drive lever 60 moves the cam groove 60e leftward in FIG. 31B to stop pushing in the suction portion 19i of the clamp lever 19. This enables the clamp lever 19 to rotate around the line C1, joining the protruding portion 19b and the end 19c together. On this occasion, the pin 20a of the spring member 20 is driven by the cam groove 601 in the second disc drive lever 60 to bend the spring portion 20b. The pin 20a thus runs on to the clamp lever 19. The spring member 20 thus generates a biasing force to cause the leading end 19k to abut against a receiving portion 60o at the leading end of the cam portion 60j of the second disc drive lever 60. This stops rotating the clamp lever 19, which is thus biased.

Thus, the clamp lever 19 is movable between the position where it does not hinder disc insertion and the sandwiched position where it does not hinder disc rotation. The spring member 20 does not bias the clamp lever 19 in the raised position, where disc insertion is not hindered, but biases the clamp lever 19 in the sandwiched position, where disc rotation is not hindered. This makes it possible to improve the safety at the position where disc insertion is not hindered and the vibration insulting property at the position where disc rotation is not hindered.

The clamp member 18 sandwiches the disc 23 between itself and the turntable of the disc drive motor 6. The clamp lever 19 thus does not hinder disc rotation. As shown in FIG. 15B, the surface of the turntable 6a of the disc driving portion 4 is inclined to the reference plane 24a of the base member 24 through the predetermined angle B. Accordingly, the height of the protruding portion 19b and the height of the receiving portion 60o are set with respect to the end 19c so that the clamp lever 19 is substantially parallel to the inclined clamp member; the receiving portion 60o is provided at the leading end of the cam portion 60j of the second disc drive lever 60.

Description will be given of centering of the clamp of the clamp member 18. In the standby state shown in FIGS. 28A and 28B, the clamp lever 19 is placed at a first angle so as to lie inside the outer shape of the base top 55. In the clamp state shown in FIGS. 31A and 31B, the clamp lever 19 is placed at a second angle. In this position, the pin 19d of the clamp lever 19 is regulated by a cam portion 60n of the cam groove 60e in the second disc drive lever 60. The hole portion 19m at one end of the clamp lever 19 is centered on the clamp member 18. To prevent the rotation of the clamp member 18 from being hindered, a neck portion 18a of the clamp member 18 is formed to be smaller than the hole potion 19m of the clamp lever 19 so that a predetermined amount of gap is created in a radial direction.

FIGS. 29A and 29B show that extension of the collapsible portion 35 allows the cam portion 29b, provided on the back side of the top surface portion 29d of the front top 29, to rotate the clamp lever 19 to drive the clamp member 18. As described above, the hole portion 19m of the clamp lever 19 is centered on the disc driving motor 6 in FIG. 13B. However, since the neck portion 18a of the clamp member 18 is formed to be smaller than the hole portion 19m, movement of the clamp member 18 lags behind rotating of the clamp lever 19 by a time corresponding to the gap. Accordingly, the clamp member 18 is not centered on the disc driving motor 6.

During a change from the state shown in FIG. 29A to the state shown in FIG. 30, the second disc drive lever 60 is rotated. The pin 19d of the clamp lever 19 is regulated by the cam portion 60m of the cam groove 60e in the second disc drive lever 60. The pin 19d is located at a third angular position opposite to the first angular position with respect to the first angular position. This rotating causes the clamp member 18 to be pushed by the hole portion 19m of the clamp lever 19 and set at a position where it is substantially centered on the disc driving motor 6.

During a change from the state shown in FIG. 30 to the state shown in FIG. 31A, the second disc drive lever 60 is further rotated. The pin 19d of the clamp lever 19 is regulated by the cam portion 60m of the cam groove 60e in the second disc drive lever 60. The clamp lever 19 is thus placed at the second angle. The clamp member 18, substantially centered on the disc driving motor 6, rotates around the line C1, joining the protruding portion 19b of the clamp lever 19 and the end 19c together. The disc 23 is thus sandwiched between the clamp member 18 and the disc driving motor 6. Thus, the clamp lever 19 moves from the first angular position through the third angular position to the second angular position to substantially center the clamp member 18 on the disc driving motor 6, providing a stable clamp mechanism.

During an unclamp operation of releasing the clamp member 18 from the disc 23, the second disc drive lever 60 is reversely operated to changed the state to the one shown FIG. 29A. On this occasion, the clamp member 18 sandwiches the disc 23 between itself and the turntable of the disc drive motor 6 under the strong magnetic force of a built-in magnet. Thus, the cam groove 60e and cam portion 60j of the second disc drive lever 60 push in the suction portion 19i and leading end 19k of the clamp lever 19 to clear the clamp state.

As described above, the above disc drive apparatus comprises the fixed portion and the collapsible portion. The collapsible portion is supported so as to be collapsible with respect to the fixed portion. The disc is inserted into the disc insertion port to extend the collapsible portion. This enables the depth dimension to be reduced while the device is unused. Further, disc insertion is carried out in the same direction as that of movement of the collapsible portion. Consequently, an operating area needs to be formed in only one direction, that is, the extending and retracting direction. This provides a disc drive apparatus that enables spaces to be saved even in the in-use state including disc insertion. The disc drive apparatus can also be incorporated easily into another apparatus. Moreover, the collapsible portion is extended only when the disc is to be inserted. This prevents the collapsible portion from flying out as a result of malfunction of the control system or the like. A disc drive apparatus is thus provided which is easy to operate and reliable and which allows size reductions.

The present invention is not limited to the above embodiments themselves. In implementation, the components of the embodiments can be modified without departing from the spirit of the present invention. Further, various inventions can be formed by appropriately combining a plurality of the components disclosed in the embodiments. For example, some of the components disclosed in the embodiments may be removed. Moreover, components from different embodiments may be appropriately combined together.

For example, the detecting portion for detecting insertion of the disc is not limited to a non-contact detection switch, and may be a non-contact sensor such as an optical sensor or the like.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A disc drive apparatus comprising:
a disc driving portion which supports and rotates a disc-shaped recording medium to execute information processing on the recording medium;
a fixed portion on which the disc driving portion is mounted;
a collapsible portion which is supported to be movable, in a predetermined extending and retracting direction, between a retracted position where the collapsible portion overlaps the fixed portion and an extended portion where the collapsible portion at least partly projects from the fixed portion to define a disc housing area capable of housing the recording medium, the collapsible portion having a leading end surface provided on the extended position side with respect to the extending and retracting direction and a disc insertion port which is formed in the leading end surface and through which the recording medium is inserted into and discharged from the disc housing area in the extending and retracting direction; and
a disc detecting mechanism which detects insertion of the recording medium,
the disc detecting mechanism including:
a detecting portion which detects insertion of the recording medium having passed through the disc insertion port;
a disc detecting stopper which is provided at the fixed portion and regulates excessive insertion of the recording medium, a medium detecting member movable among a first position corresponding to non-insertion of the recording medium, a second position where the detecting portion is actuated, and an intermediate position located between the first position and the second position; and
a first disc detecting lever which is rotatably provided at the fixed portion and which rotates to move the medium detecting member, and a second disc detecting lever rotatably provided on the first disc detecting lever and having a first abutting portion which abuts against the inserted recording medium and is pushed in the inserting direction of the recording medium, and a second abutting portion capable of abutting against the disc detecting stopper,
wherein in response to insertion of the recording medium, the first disc detecting lever and second disc detecting lever are rotated to cause the second abutting portion to abut against the disc detecting stopper and to move the medium detecting member from the first position to the intermediate position, and in response to further insertion of the recording medium, the second disc detecting lever abutting against the disc detecting stopper rotates around the second abutting portion to rotate the first disc detecting lever to move the medium detecting member from the intermediate position to the second position.

2. The disc drive apparatus according to claim 1, wherein a ratio of an amount of rotating of the second disc detecting lever to an amount by which the recording medium is inserted during movement of the medium detecting member from the intermediate position to the second position is higher than that of the amount of rotating of the second disc detecting lever to the amount by which the recording medium is inserted during movement of the medium detecting member from the first position to the intermediate position.

3. The disc drive apparatus according to claim 1, which further comprises an extension and retraction driving mechanism which includes a driving source and a transmission mechanism transmitting a driving force of the driving source, and which moves the collapsible portion in the extending and retracting direction with respect to the fixed portion,
wherein the medium detecting member has an engaging portion which regulates an operation of the extension and retraction driving mechanism at the first position and which allows the operation of the extension and retraction driving mechanism at the second position.

4. The disc drive apparatus according to claim 1, wherein the medium detecting member has a lever provided at the fixed portion and rotatable in response to insertion of the recording medium, and the detecting portion has a detecting switch configured to be switched by the lever having rotated to the second position.

5. A disc drive apparatus comprising:
a disc driving portion which supports and rotates a disc-shaped recording medium to execute information processing on the recording medium;
a fixed portion on which the disc driving portion is mounted;
a collapsible portion which is supported to be movable, in a predetermined extending and retracting direction, between a retracted position where the collapsible portion overlaps the fixed portion and an extended portion where the collapsible portion at least partly projects from the fixed portion to define a disc housing area capable of housing the recording medium, the collapsible portion having a leading end surface located on a side of the extended position direction with respect to the extending and retracting direction and a disc insertion port which is formed in the leading end surface and through which the recording medium is inserted into and discharged from the disc housing area in the extending and retracting direction;
an extension and retraction driving mechanism which includes a driving source and a transmission mechanism which transmits a driving force of the driving source and which moves the collapsible portion in the extending and retracting direction with respect to the fixed portion;
a detecting portion which detects insertion of the recording medium having passed through the disc insertion port;
an alarm device configured to give an alarm indicating movement of the collapsible portion to the extended portion; and
a control portion which actuates the alarm device to give the alarm when the detecting portion detects insertion of the recording medium.

6. The disc drive apparatus according to claim 5, wherein the alarm device has a sound generating device which outputs a sound.

7. The disc drive apparatus according to claim 5, wherein the alarm device has a light emitting device which emits light.

8. The disc drive apparatus according to claim 5, wherein the alarm device has a display device which displays an image.

9. A disc drive apparatus comprising:
a disc driving portion which supports and rotates a disc-shaped recording medium to execute information processing on the recording medium;
a fixed portion on which the disc driving portion is mounted;
a collapsible portion which is supported to be movable, in a predetermined extending and retracting direction, between a retracted position where the collapsible portion overlaps the fixed portion and an extended portion where the collapsible portion at least partly projects from the fixed portion to define a disc housing area capable of the recording medium, the collapsible portion having a leading end surface located on a side of the extended position with respect to the extending and retracting direction and a disc insertion port which is formed in the leading end surface and through which the recording medium is inserted into and discharged from the disc housing area in the extending and retracting direction; and
a driving mechanism including a driving source and a transmission mechanism which transmits a driving force of the driving source, the driving mechanism, while the recording medium has not been inserted, holding a standby state in which the collapsible portion is held in the extended position with the disc driving portion positioned in the fixed portion, the driving mechanism, when the recording medium is inserted, moving the collapsible portion to the extended position and moving the disc driving portion to a driven position where the recording medium is driven to change to a clamp state, the driving mechanism, when the recording medium is to be ejected, changing the state to an eject state in which the collapsible portion is moved to the retracted position and in which the disc driving portion is moved into the fixed portion, the driving mechanism having the standby state wherein the recording medium is allowed to be inserted, the clamp state, and the eject state located opposite the clamp state with respect to the standby state.
